(19) United States
(12) Patent Application Publication
(10) Pub. No.: US 2010/0283605 A1
(43) Pub. Date: Nov. 11, 2010

(54) INDUCTION LAMP LIGHT FIXTURE

(76) Inventor: Michael Olen NEVINS, Jackson, MI (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/774,551

(22) Filed: May 5, 2010

Related U.S. Application Data
(60) Provisional application No. 61/175,664, filed on May 5, 2009.

(51) Int. Cl. G08B 21/00; F21V 7/00; H05B 37/02

(52) U.S. Cl. 340/540; 340/686.1; 340/541; 362/310; 315/291

(57) ABSTRACT

A light fixture for an induction-based light source is described. The light fixture comprises a top cover; a lower cover coupled with the top cover; a lens coupled with the lower cover; a reflector positioned behind the lens; and an induction-based light source positioned between the lens and the reflector, wherein the reflector is configured in relation to the induction-based light source.

### RELATED APPLICATIONS

The present application is based on, and claims priority from, Provisional Application No. 61/175,664, filed May 5, 2009, and is related to U.S. patent application Ser. No. 12/248,693, filed Oct. 9, 2008 and International Application Number PCT/US2008/82939, filed Nov. 10, 2008, the disclosures of which are hereby incorporated by reference herein in their entirety.

### BACKGROUND

Induction fluorescent lamps offer the potential for increased life, lumen maintenance and efficacy for lighting applications.

Many lighting applications employing an induction fluorescent lamp will result in a fairly diffusive distribution characteristic in terms of the flux exiting the fixture. The diffusive nature of the distribution limits, both the controlled distribution of the light pattern from the fixture and the resultant effective area of illuminated horizontal surface such as a road surface. Furthermore, the diffusive nature of the induction lamp also presents challenges in terms of fixture efficiency relative to the amount of light that gets trapped within a fixture geometry.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a side view of a street lamp having a cobra head light fixture according to an embodiment;

FIG. 2 is a perspective view of a cobra head light fixture according to an embodiment;

FIG. 3 is a reverse perspective view of the cobra head light fixture of FIG. 2;

FIG. 4 is a rear perspective view of the cobra head light fixture of FIG. 2;

FIG. 5 is a front elevation view of the cobra head light fixture of FIG. 2;

FIG. 6 is a rear elevation view of the cobra head light fixture of FIG. 2;

FIG. 7 is a right side elevation view of the cobra head light fixture of FIG. 2;

FIG. 8 is a left side elevation view of the cobra head light fixture of FIG. 2;

FIG. 9 is a top plan view of the cobra head light fixture of FIG. 2;

FIG. 10 is a bottom plan view of the cobra head light fixture of FIG. 2;

FIG. 11 is a left rear view of the cobra head light fixture of FIG. 2;

FIG. 12 is a bottom right view of the cobra head light fixture of FIG. 2;

FIG. 13 is a left side section view of the cobra head light fixture of FIG. 2;

FIG. 14 is a right side section view of the cobra head light fixture of FIG. 2;

FIG. 15 is a right rear perspective view of the cobra head light fixture of FIG. 2 with an upper cover removed;

FIG. 16 is a left rear perspective view of the cobra head light fixture of FIG. 2 with the upper cover removed;

FIG. 17 is a top plan view of the cobra head light fixture of FIG. 2 with the upper cover removed;

FIG. 18 is a bottom plan view of the cobra head light fixture of FIG. 2 with a lower optic lens removed;

FIG. 19 is a left side elevation view of the cobra head light fixture of FIG. 2 with the upper cover removed;

FIG. 20 is a front elevation view of the cobra head light fixture of FIG. 2 with the upper cover removed;

FIG. 21 is a front perspective view of the cobra head light fixture of FIG. 2 with the upper cover removed;

FIG. 22 is a front elevation view of the cobra head light fixture of FIG. 2 with the upper cover and lower optic lens removed;

FIG. 23 is a rear elevation view of the cobra head light fixture of FIG. 2 with the upper cover and lower optic lens removed;

FIG. 24 is a top plan view of the cobra head light fixture of FIG. 2 with the upper cover removed;

FIG. 25 is a bottom plan view of the cobra head light fixture of FIG. 2 with the lower optic lens removed;

FIG. 26 is a right perspective view of the lower optic lens of the cobra head light fixture of FIG. 2;

FIG. 27 is a front elevation view of the lower optic lens of the cobra head light fixture of FIG. 2;

FIG. 28 is a right side elevation view of the lower optic lens of the cobra head light fixture of FIG. 2

FIG. 29 is a rear elevation view of the lower optic lens of the cobra head light fixture of FIG. 2;

FIG. 30 is a top interior plan view of the lower optic lens of the cobra head light fixture of FIG. 2;

FIG. 31 is a bottom exterior plan view of the lower optic lens of the cobra head light fixture of FIG. 2;

FIG. 32 is a lower rear perspective view of the lower optic lens of the cobra head light fixture of FIG. 2;

FIG. 33 is a lower front perspective view of the lower optic lens of the cobra head light fixture of FIG. 2;

FIG. 34 is a depiction of candle distribution of the cobra head light fixture according to an embodiment;

FIG. 35 is a depiction of another candle distribution of the cobra head light fixture according to an embodiment;

FIG. 36 is a depiction of another candle distribution of the cobra head light fixture according to an embodiment;

FIG. 37 is a right bottom perspective view of the cobra head light fixture of FIG. 2 with the lower optic lens removed;

FIG. 38 is a rear bottom perspective view of the cobra head light fixture of FIG. 2 with the lower optic lens removed;

FIG. 39 is a collection of views of a shoebox head light fixture according to another embodiment;

FIG. 40 is a bottom plan view of the shoebox head light fixture of FIG. 39;

FIG. 41 is a side plan view of the shoebox head light fixture of FIG. 39;

FIG. 42 is a depiction of candle distribution of the shoebox head light fixture of FIG. 30; and

FIG. 43 is a side perspective view of a garage or canopy light fixture according to an embodiment;

FIG. 44 is a side plan view of the garage or canopy light fixture of FIG. 43;

FIG. 45 is a depiction of candle distribution of the garage or canopy light fixture of FIG. 43;

FIG. 46 is a side perspective view of a wall pack light fixture according to an embodiment;

FIGS. 47A and 47B are side and top plan views, respectively, of the wall pack light fixture of FIG. 46;

FIG. 48 is a depiction of candle distribution of the wall pack light fixture of FIG. 46;

FIG. 49 is a side perspective view of a walkway light fixture according to an embodiment;

FIGS. 50A and 50B are side views of the light fixture of FIG. 46 and a base according to an embodiment for use with the light fixture of FIG. 46;

FIG. 51 is a depiction of candle distribution of the walkway light fixture of FIG. 49 having type V prismatic refractor optics;

FIG. 52 is a depiction of foot candle plot of the walkway light fixture of FIG. 49 having type V prismatic refractor optics;

FIG. 53 is a depiction of candela plot of the walkway light fixture of FIG. 49 having type V prismatic refractor optics;

FIG. 54 is a depiction of candle distribution of the walkway light fixture of FIG. 49 having type III prismatic refractor optics;

FIG. 55 is a depiction of foot candle plot of the walkway light fixture of FIG. 49 having type III prismatic refractor optics;

FIG. 56 is a depiction of candela plot of the walkway light fixture of FIG. 49 having type III prismatic refractor optics;

FIG. 57 is a high-level functional block diagram of a controller according to an embodiment;

FIG. 58 is a side view of a street lamp having a cobra head light fixture according to another embodiment;

FIG. 59 depicts a high-level functional process flow of at least a portion of lighting control system according to an embodiment;

FIG. 60 is a top plan view of a light fixture according to another embodiment;

FIG. 61 is a side view of the light fixture of FIG. 60;

FIG. 62 is a side section view of the light fixture of FIG. 60;

FIG. 63 is an isometric view of the light fixture of FIG. 60;

FIG. 64 is an other isometric view of the light fixture of FIG. 60;

FIG. 65 is a bottom view of the light fixture of FIG. 60;

FIG. 66 is a perspective view of a cobra head light fixture reflector according to an embodiment similar to FIG. 24; and

FIG. 67 is a perspective view of a cobra head light fixture reflector according to another embodiment similar to FIG. 66.

### DETAILED DESCRIPTION

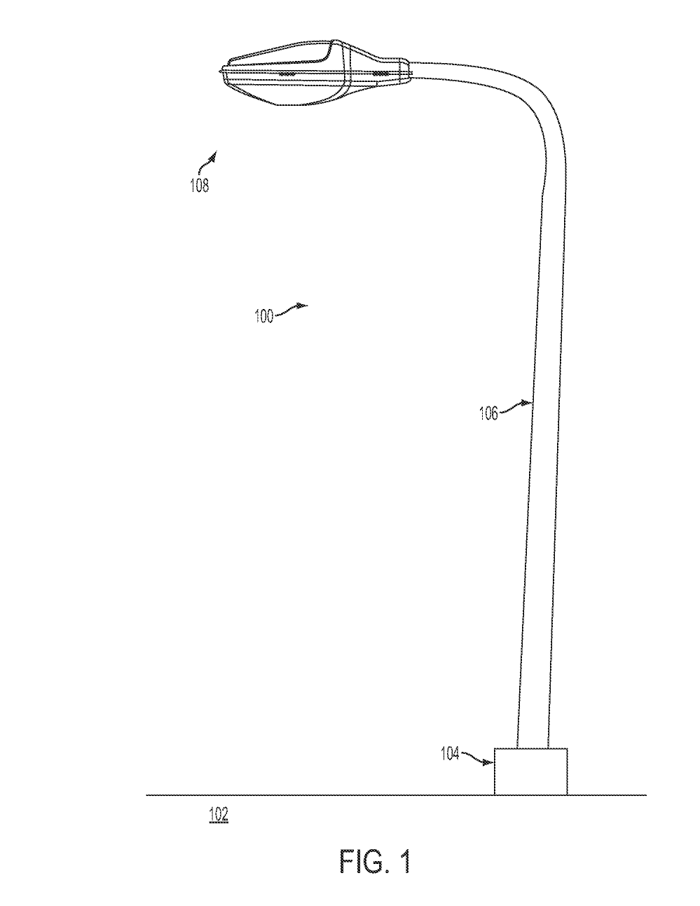

FIG. 1 depicts a perspective view of a lighting device 100 having a cobra head light fixture according to an embodiment of the present invention. Lighting device 100 is installed on a surface 102 by way of a pedestal 104. In at least some embodiments, surface 102 comprises ground, roadway, or other supporting surface. In at least some embodiments, pedestal 104 comprises any of a number of supportive materials such as stone, concrete, metal, etc.

Lighting device 100 comprises a vertically extending support pole 106. In at least some embodiments, support pole 106 may extend horizontally or at a different angle in-between horizontal and vertical. In at least some embodiments, support pole 106 is hollow; however, in other embodiments different configurations may be possible. In at least some embodiments, support pole 106 may be comprised of metal, plastic, concrete and/or a composite material.

In at least some embodiments, support pole 106 also provides a conduit through which electricity is supplied to the light fixture. For example, a connection to a mains or other power source may be provided.

Lighting device 100 comprises a light fixture 108, i.e., a cobra head light fixture physically connected to support pole 106. Cobra head light fixture 108 comprises an induction-based light source for providing illumination to an area adjacent support pole 106.

Light fixture 108 is an induction-based light source in order to provide increased lifespan and/or reduce a required initial energy requirement for illumination. An induction-based light source does not use electrical connections through a lamp in order to transfer power to the lamp. Electrode-less lamps transfer power by means of electromagnetic fields in order to generate light. In an induction-based light source, an electric frequency generated from an electronic ballast is used to transfer electric power to an antenna coil within the lamp. In accordance with at least some embodiments, light fixture 108 may have an increased lifespan with respect to other types, e.g., incandescent and/or florescent light sources having electrodes. In accordance with at least some embodiments, light fixture 108 may have a reduced initial energy requirement for start up of the light source. In at least some embodiments, lighting device 100 receives power from a 24 volt power source for provision to lighting fixture 108. In at least some other embodiments, lighting device 100 receives power from a mains power supply and converts the received power to a 24 volt power level for use by lighting fixture 108.

In at least some embodiments, light fixture 108 is electrically connected, either directly or indirectly, to a power source. In at least some alternate embodiments, lighting device 100 may comprise more than one light fixture. In at least some embodiments, light fixture 108 may be arranged to provide illumination in a directional manner, i.e., downward, upward, etc., with respect to an orientation of the light source. In at least some embodiments, lighting device 100 may comprise a plurality of light fixtures arranged at differing elevations and/or at different angular spacing about support pole 106.

In at least some embodiments, induction-based light fixture 108 comprises a light sensor arranged to trigger activation of the induction-based light source based on a detected light level. In at least some embodiments, the detected light level is determined with respect to a particular area proximate support pole 106.

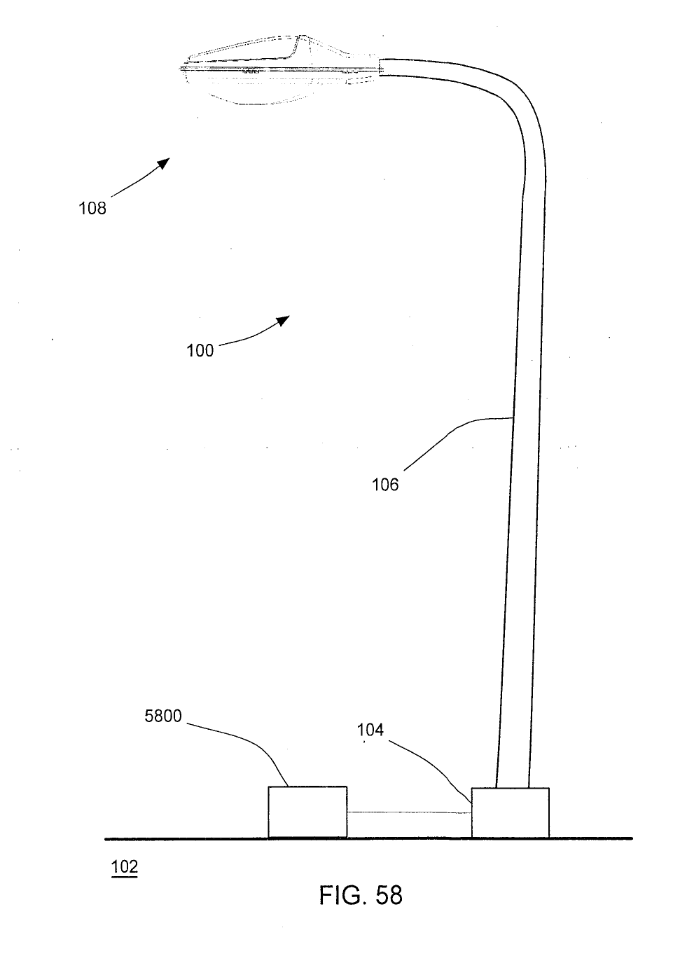

In at least some embodiments, induction-based light fixture 108 comprises a controller integral with the light fixture for controlling activation and/or operation of the light fixture. In at least some other embodiments, lighting device 100 comprises the controller integral thereto, e.g., attached to or within support pole 106, for controlling activation and/or operation of the light fixture. In at least some still further embodiments (for example, as depicted in FIG. 58), lighting device 100 is coupled to an external controller 5800 configured to control activation and/or operation of light fixture 108 and/or lighting device 100.

Cobra head light fixtures which have enhanced lateral, and generally outward distribution characteristics significantly enhance their utility and efficiency in roadway application by maximizing the area of effectively illuminated roadway surface. Specifically, enhanced fixture geometries that reduce the flux at nadir while enhancing the flux between 45° and 90° results in a much more effective and efficient distribution characteristic for roadway and exterior lighting applications. This enhancement results in significantly lower levels of modulation as defined as the ratio of maximum and minimum light levels between fixture heads and contributes to the evenness of illuminance distribution characteristics on horizontal surfaces and roadways.

Reducing modulation, in at least some embodiments, reduces the number of fixtures required in a specified area required to maintain a specified illuminance level, thereby reducing capital and energy costs.

Secondly in at least some embodiments, induction-based fixtures have relatively low fixture efficiencies due to the relatively large size of the tubular geometry of the typical induction lamp relative to the size of the primary reflector surfaces within the fixture. This ratio limits the amount of flux that exits the fixture due to internal entrapment. Internal fixture losses are primarily due to the occlusion of inter-reflections within the lamp fixture geometry. In this case, fixture efficiency is defined as the ratio of the total amount of flux, exiting a fixture relative to the total amount of light produced by the lamp. In the energy efficiency arena, maximizing fixture efficiency is vitally important for energy savings, particularly in roadway applications.

Developing wider distribution characteristics, and increasing the fixture efficiency for cobra head type applications is particularly important in at least some embodiments in order to achieve increases in power efficiency in the way we illuminate the roadway and related exterior lighting applications including parking, walkway and pathway applications.

One or more embodiments of the present invention describe a novel induction based cobra head fixture geometry that employs multiple internal optics and lamp positioning for enhanced distribution and fixture efficiency characteristics.

The enhanced optics include one or more of the following specific embodiments:

1) Concave optics—A radially symmetric, concave and reentrant convex reflector is positioned over the circular geometry of the induction lamp that enhances the internal cavity reflection out of the fixture body. The concavity is symmetrically positioned around a reentrant convex cone that is aligned with the center axis of the induction lamp. This radially symmetric, concave surface acts as a primary reflector and enhances the internal reflection process. Flux being directed upwards and to the center of the fixture concavity is directed outwards, thereby enhancing the optical efficiency of the overall fixture. This internal concavity reduces the amount of entrapment losses that occur with traditional flat or simple curved optics.

This radially symmetric reflector positioned over the circular geometry of the induction lamp enhances the overall fixture efficiency by maximizing the effectiveness of the internal reflection. A larger proportion of the upward emerging flux experiences a single or secondary reflection out of the fixture cavity. This novel, radially symmetric internal reflector enhances the overall fixture efficiency for induction type lamp geometries.

2) Lamp positioning—the cobra head employs an enhanced lamp positioning within the geometry of the fixture cavity increasing the forward flux distribution which contributes to a wider distribution. This is particularly important in roadway applications in at least some embodiments where one is interested in maximum light distribution forward from the actual pole mounted fixture head. The front surface of the upper reflector positioned forward of the induction lamp has been designed to provide an enhancement on the forward distribution from the cobra head geometry. Flux exiting the lamp geometry, at 90° to approximately 120° will experience a single reflection on this forward mounted reflector.

The lamp is uniquely positioned within the reflective and transmissive optics, such that no direct component exits the fixture above 90°, thereby enhancing the dark sky friendliness of this geometry. In at least some embodiments, a minimum amount of direct component exits the fixture above 90°.

3) Transparent optic—the lower half of the cobra head fixture is encapsulated within a single transparent optical unit. This encapsulation allows for both direct transmission of flux from the lamp and direct transmission from inter-reflections from the upper reflector.

The surrounding sides of the transparent encapsulation are sized and angled to produce as much surface normal to exiting flux as possible. The normal position of the transparent surfaces reduces the amount of surface losses that occur. This normal positioning of the encapsulating surround also enhances the lateral distribution characteristics out of the fixture. The large almost vertical sides of the transparent material allow for an enhanced lateral distribution contributing to a much wider distribution of flux on horizontal surfaces, thereby reducing modulation and enhancing evenness of illuminance on roadway surfaces.

4) Refractor optics—a radially symmetric refractor geometry is molded into the lower encapsulation as an integral element. This refractor geometry is designed explicitly to maximize the lateral distribution of flux, exiting the fixture. Flux, emitted directly downwards within 30 to 40° from nadir from the induction lamp is refracted as it passes through the encapsulated lens geometry. The integrally molded refractor geometry reduces the flux at nadir and enhances the outward redirection of flux contributes to a much wider distribution from the cobra head fixture.

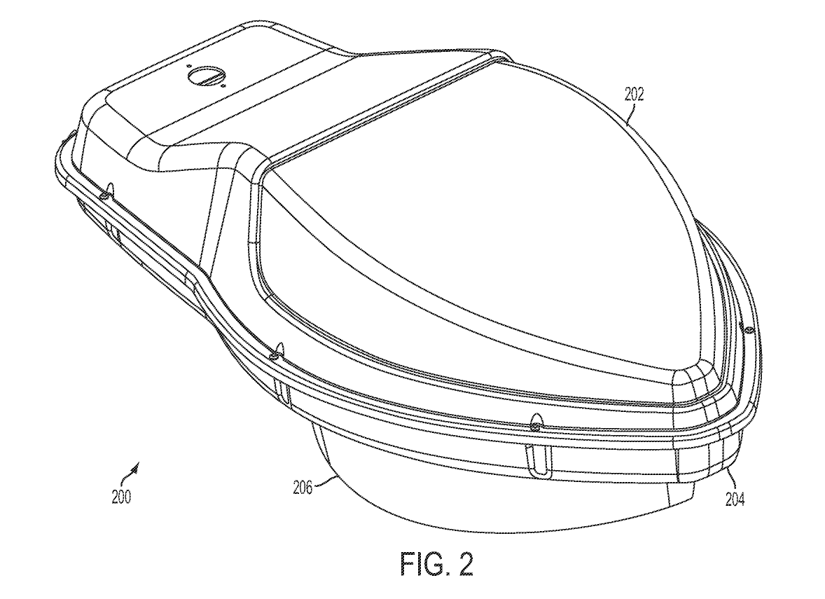

FIG. 2 depicts a front perspective view of a cobra head light fixture 200 according to an embodiment, e.g., light fixture 108 (FIG. 1) may be a cobra head light fixture as depicted in FIG. 2. Light fixture 200 comprises a top cover 202, a lower cover 204, and a lens 206 connected together. In at least some embodiments, top cover 202 is connected directly to at least lower cover 204. Lens 206 covers an induction-based light source, e.g., an induction-based light bulb, and directs the illumination provided by the light source from the light fixture 200.

In at least some embodiments, light fixture 200 comprises a specular reflector optimized for induction lamp geometry. In at least some embodiments, lens 206 is an acrylic lens with Type III, medium throw prescription optics.

Due to the use of the induction-based light source, top cover 202 and/or lower cover 204 may be constructed of a polycarbonate material. In at least some embodiments, top cover 202 is removably connected to lower cover 204. In at least some embodiments, lens 206 is removably connected to lower cover 204.

In at least some embodiments, lens 206 is transparent. In at least some other embodiments, lens 206 is at least partially transparent.

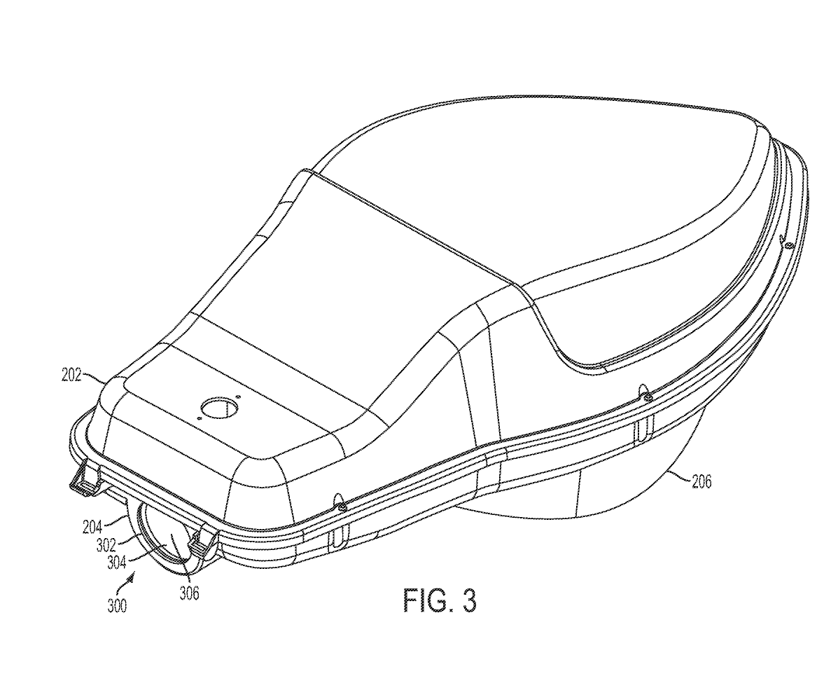

FIG. 3 depicts a rear perspective view of cobra head light fixture 200 according to an embodiment. Lower cover 204 comprises a connection point 300 for connecting light fixture 200 to support pole 106 (FIG. 1). Connection point 300 comprises a throughhole 302 to the interior of light fixture 200. Throughhole 302 surrounds a sleeved portion 304 of a casting 306, described in more detail below.

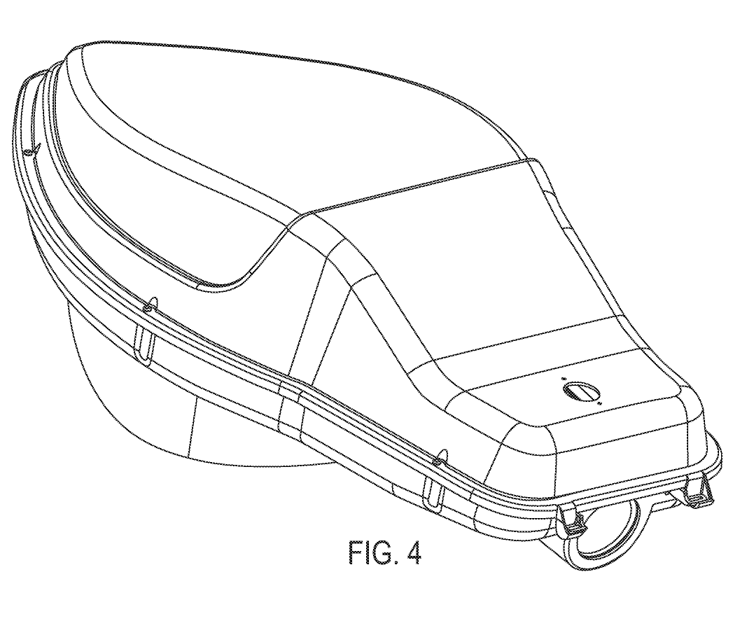

FIG. 4 depicts a rear right side perspective view of light fixture 200.

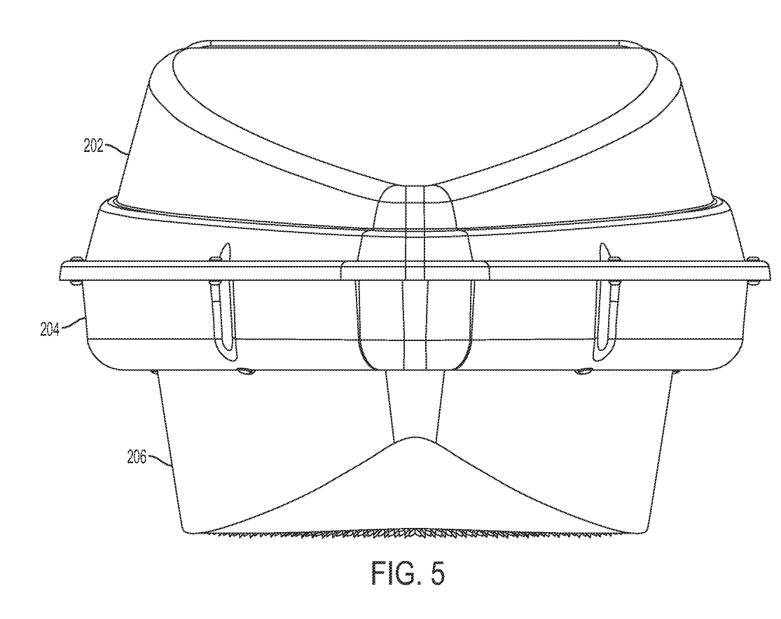

FIG. 5 depicts a front elevation view of light fixture 200.

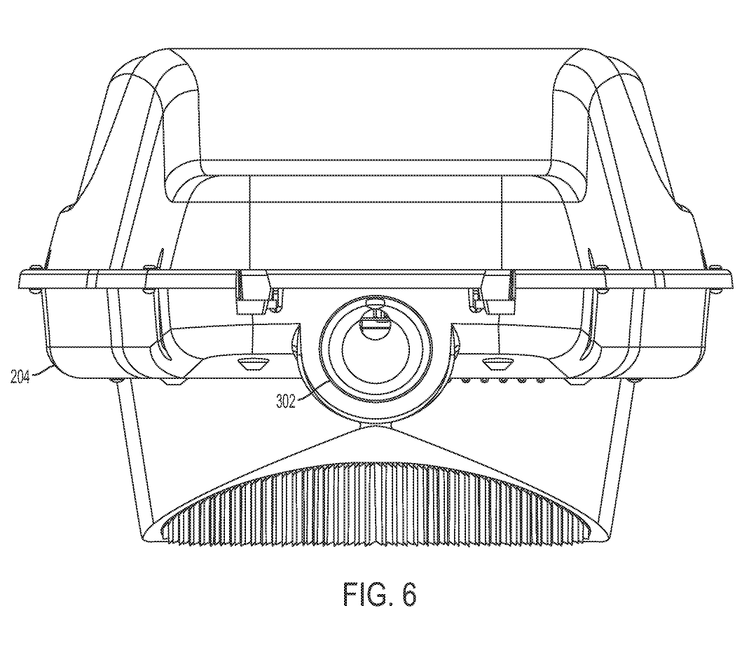

FIG. 6 depicts a rear elevation view of light fixture 200. Throughhole 302 of lower cover 204 is visible in FIG. 6.

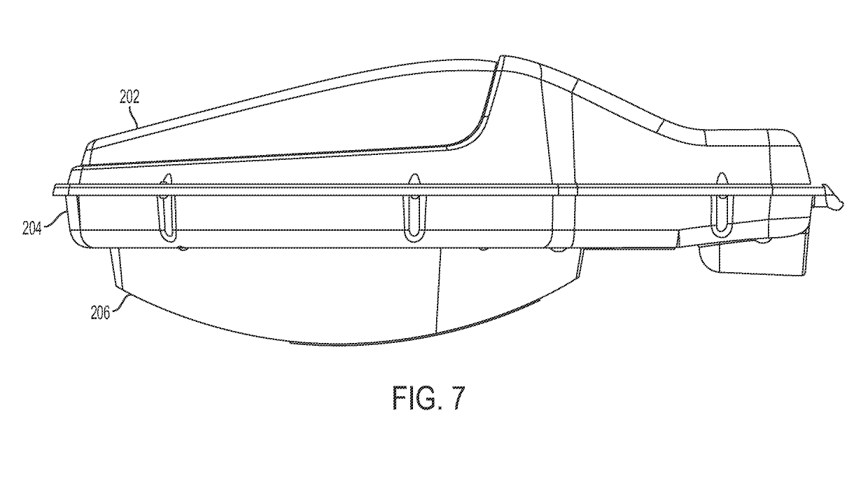

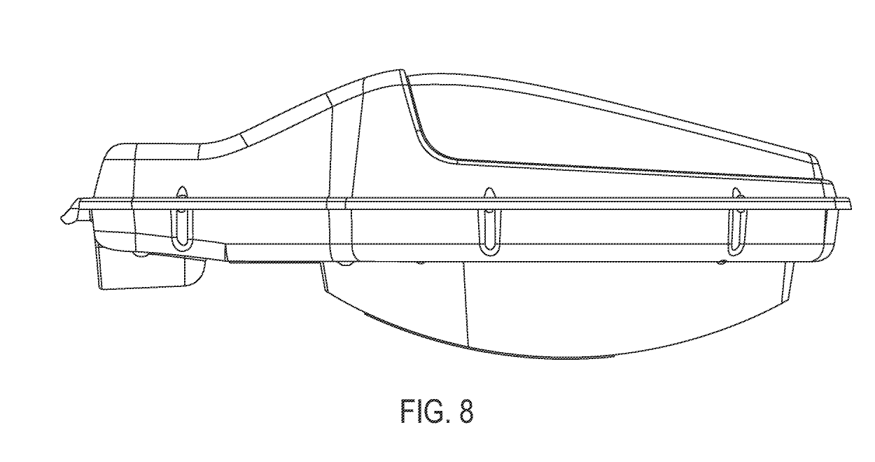

FIG. 7 depicts a right side elevation view of light fixture 200 and FIG. 8 depicts a left side elevation view of the light fixture.

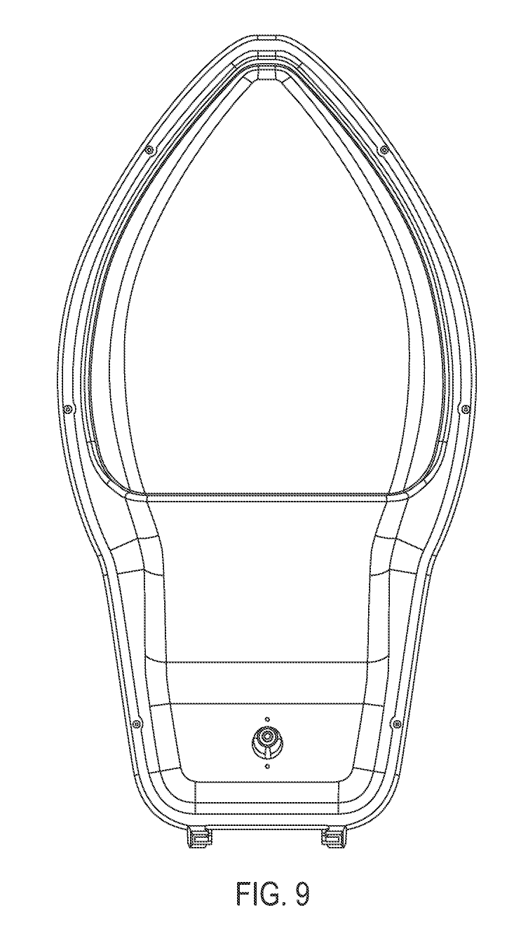

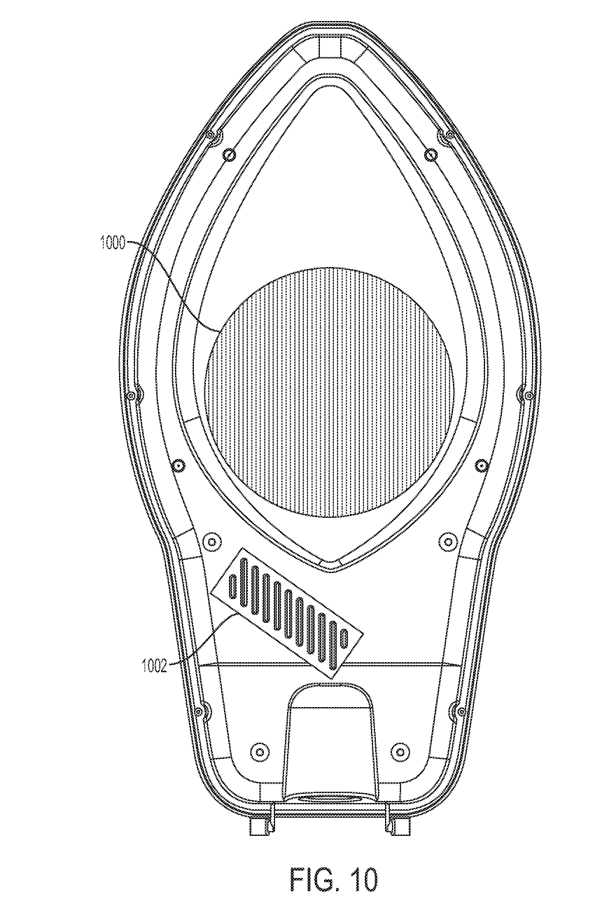

FIG. 9 depicts a top plan view of light fixture 200 and FIG. 10 depicts a bottom plan view of the light fixture.

As depicted in FIG. 10, lens 206 comprises an integrated refractor optic portion 1000, as described above. Also, an integrated heat sink 1002 is visible in FIG. 10. In at least some embodiments, heat sink 1002 is formed as an integrated portion of casting 306 (FIG. 3). In at least some embodiments, casting 306 structurally connects light fixture 200 to support pole 106 (FIG. 1) and lower cover 204. Additionally, casting 306 comprises heat sink 1002 for light fixture 200. In at least some embodiments, the integrated nature of heat sink 1002 enable an extended system life.

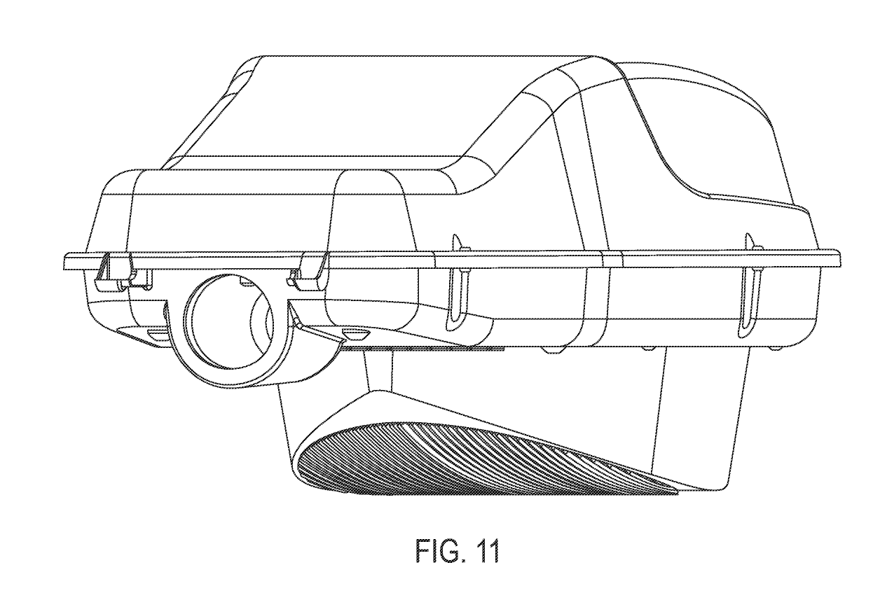

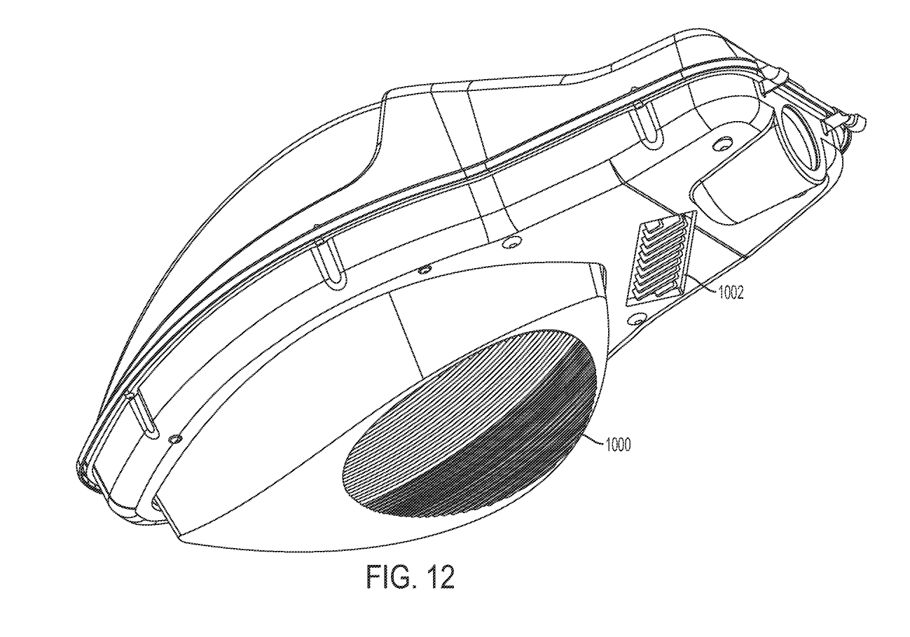

FIG. 11 depicts a left rear perspective view of light fixture 200 and FIG. 12 depicts a bottom right perspective view of the light fixture in which refractor optic portion 1000 is visible.

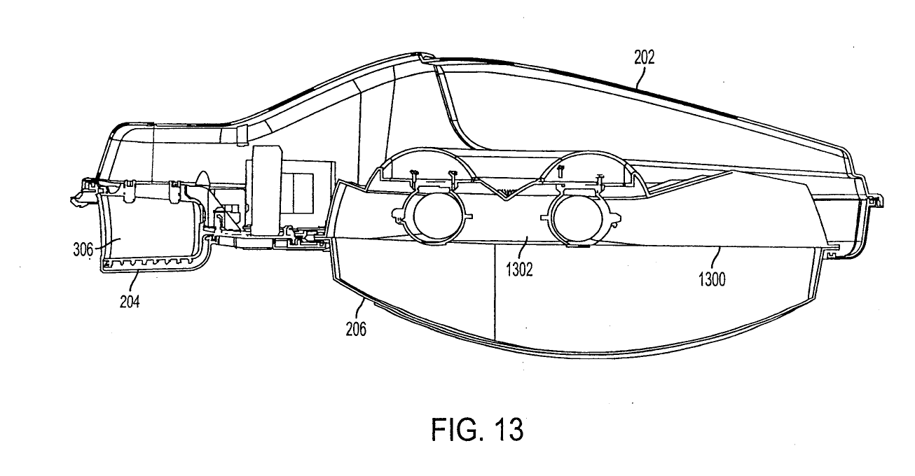

FIG. 13 depicts a left side cross-section view of light fixture 200. Visible in FIG. 13 are a reflector 1300 connected with lens 206 and within lower cover 204 and a portion top cover 202. In at least some embodiments, reflector 1300 is connected with lower cover 204 and not to lens 206. Reflector 1302 is arranged to reflect illumination received from an induction-based light source 1302 through lens 206.

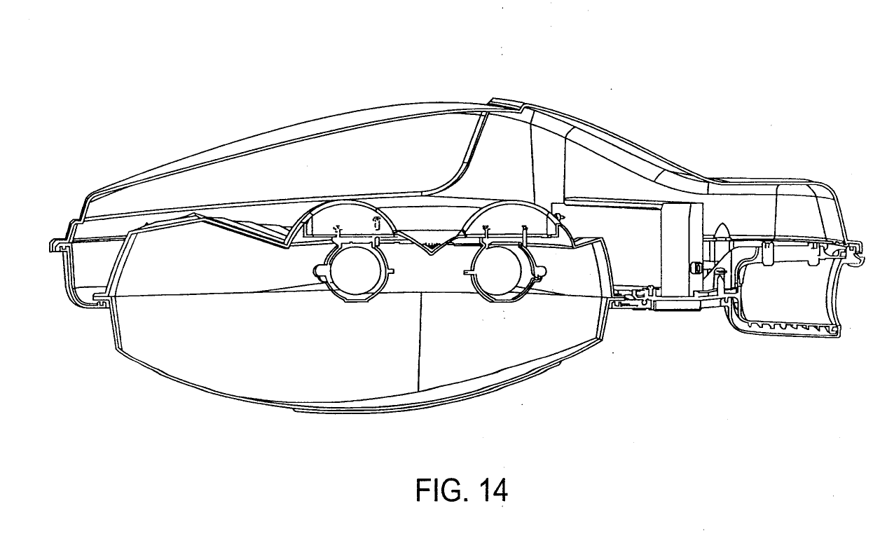

FIG. 14 depicts a right side cross-section view of light fixture 200.

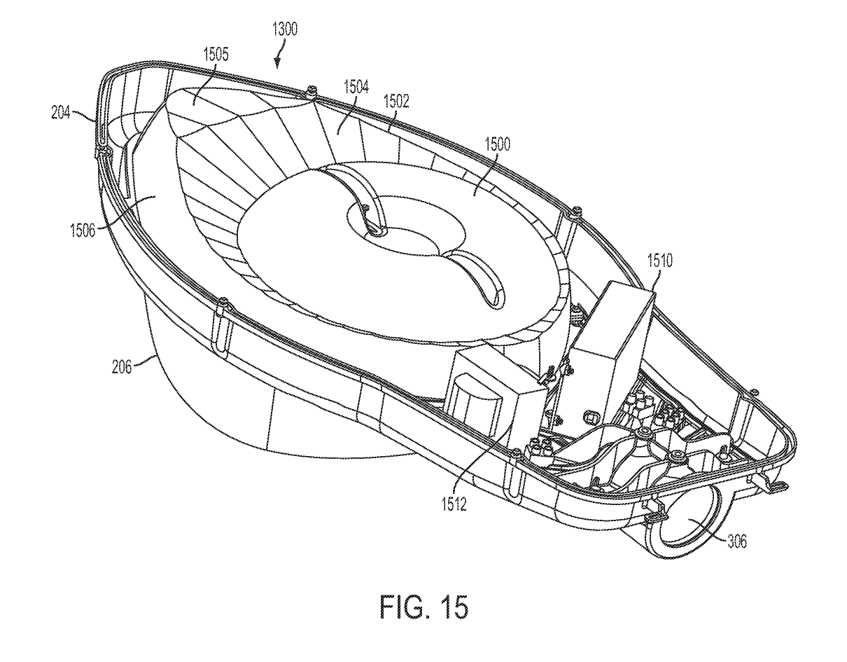

FIG. 15 depicts a right rear perspective view of light fixture 200 with top cover 202 removed. The upper exterior of reflector 1300 is visible within light fixture 200. A central hemispherical (half donut-shaped) convex, when viewed from the top, portion 1500 of reflector 1300 corresponds to a region of the reflector within which an induction-based light source is positioned on the underside. In at least some embodiments, central hemispherical portion 1500 is less than hemispherical comprising a cord slice of a sphere.

An upward extending, when viewed from the top, peripheral region 1502 extends from the circular edge of central hemispherical portion 1500. Peripheral region 1502 forms a radially extending reflector having a plurality of internal reflection panels 1504 radially spaced around the central hemispherical portion 1500. In at least some embodiments, reflection panels 1504 comprise a curvature at the end distal from the edge of central hemispherical portion 1500.

In at least one embodiment, peripheral region 1502 comprises a horizontally extending portion 1505. Horizontally extending portion 1505 extends horizontally from peripheral region 1502 along a portion of the perimeter of peripheral region 1502 and comprises one or more reflection panels similar to internal reflection panels 1504. In at least some embodiments, the reflection panels of horizontally extending portion 1505 extend one or more internal reflection panels 1504 radially outward from central hemispherical portion 1500.

A downward extending, when viewed from the top, surround region 1506 extends from the edge of peripheral region 1502. Surround region 1506 extends toward lower cover 204 and lens 206. In at least some embodiments, reflector 1300 further comprises a flange extending around the perimeter of surround region 1506 for mounting the reflector to either or both of lower cover 204 and/or lens 206.

A driver 1510 usable in conjunction with light source 1302 and a transformer 1512 are also visible. Driver 1510 is connected with casting 306 (FIG. 3) and positioned atop heat sink 1002. Transformer 1512 is also connected with casting 306. Driver 1510 and transformer 1512 are electrically coupled with each other.

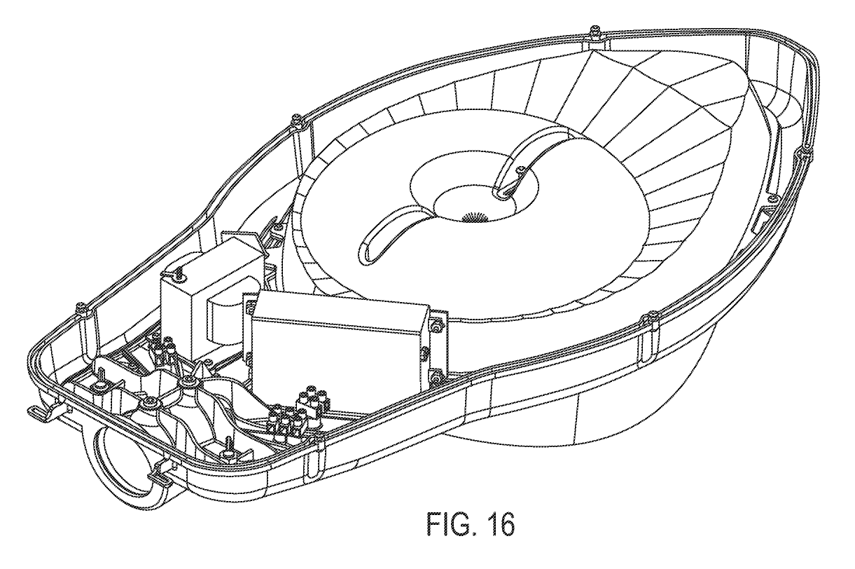

FIG. 16 depicts a left rear perspective view of light fixture 200.

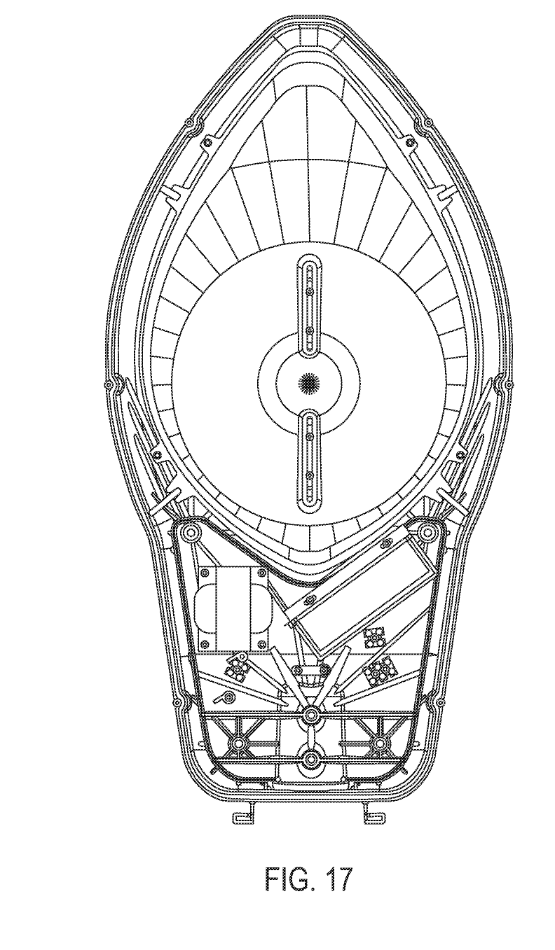

FIG. 17 depicts a top plan view of light fixture 200 with top cover 202 removed. The position of driver 1510 and transformer 1512 is visible. Also, the shape of reflector 1300 is visible. Reflector 1300 is generally ellipsoid with a central raised portion and optically reflective panels radiating outward from the central raised portion.

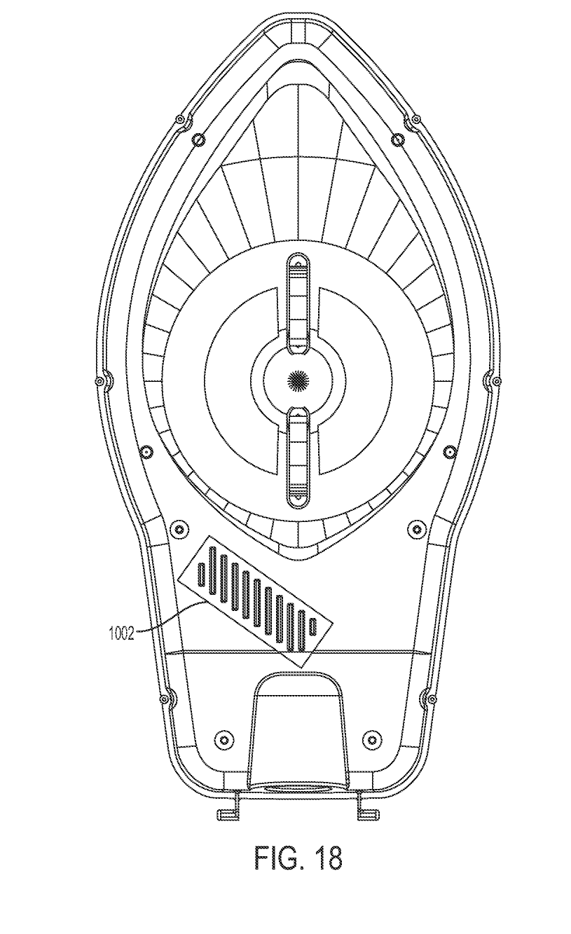

FIG. 18 is a bottom plan view of light fixture 200 with lens 206 removed. The position of heat sink 1002 is visible. Heat sink 1002 is positioned corresponding to driver 1510.

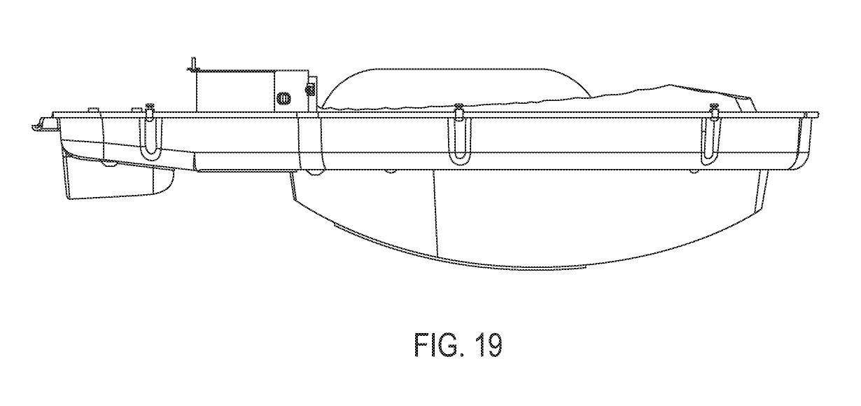

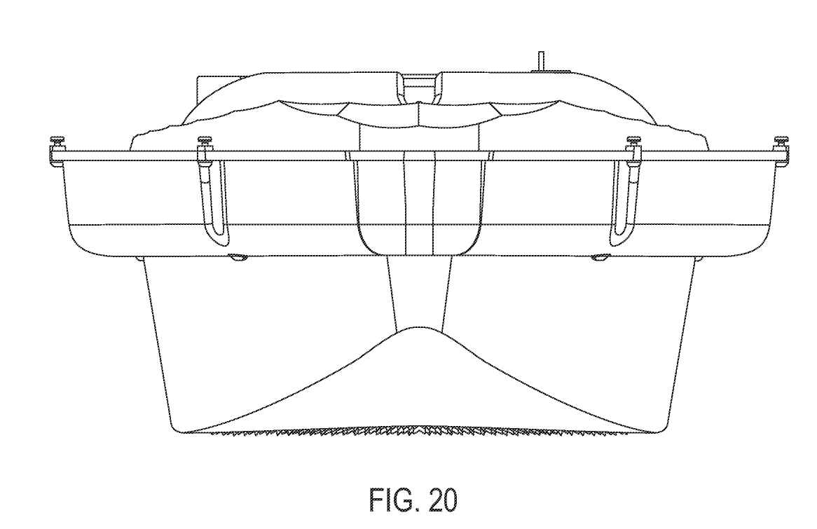

FIGS. 19 and 20 are a left side elevation view and front elevation view of light fixture 200 with top cover 202 removed.

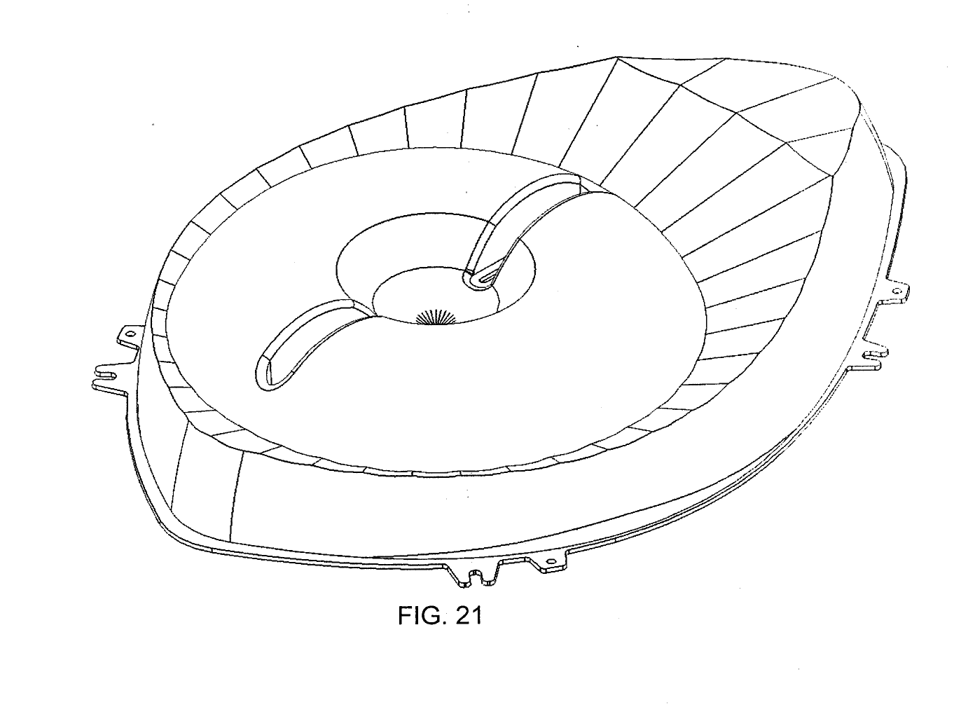

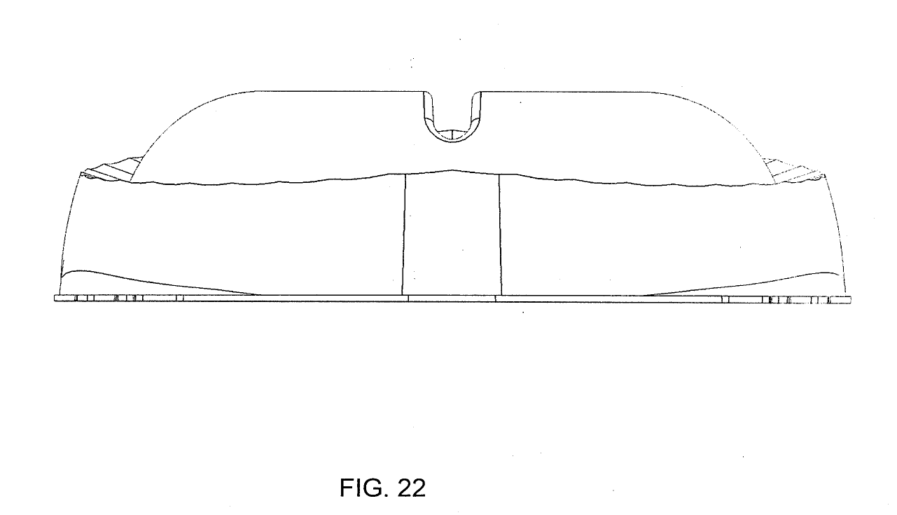

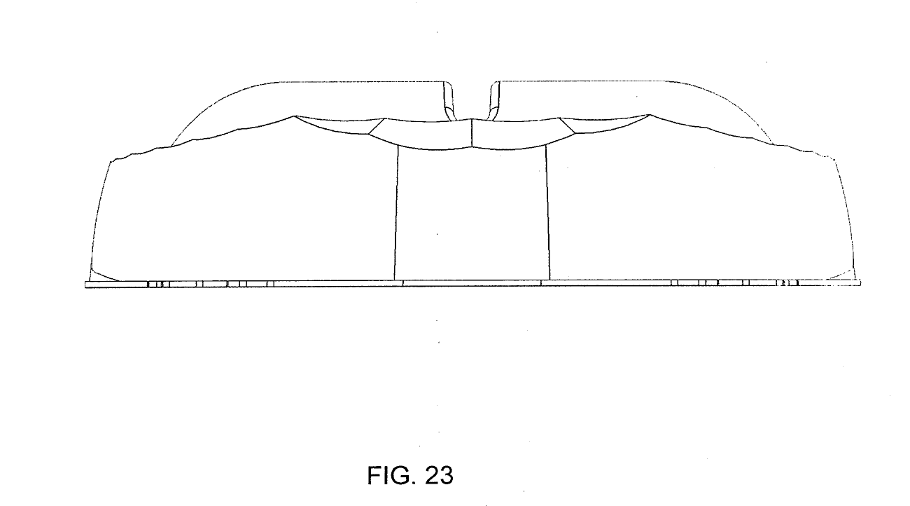

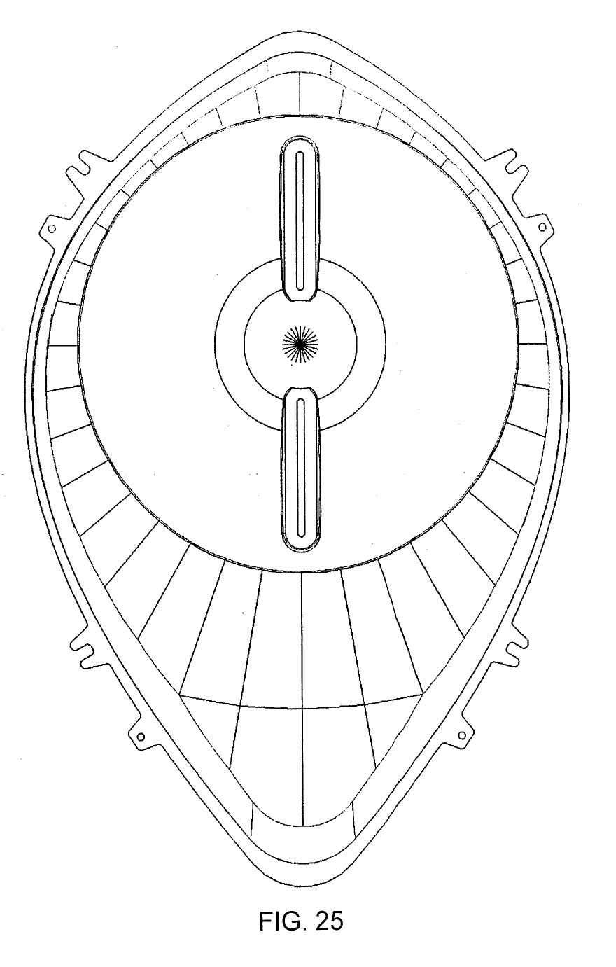

FIGS. 21-25 are front perspective, front elevation, rear elevation, top plan, and bottom plan views, respectively, of reflector 1300.

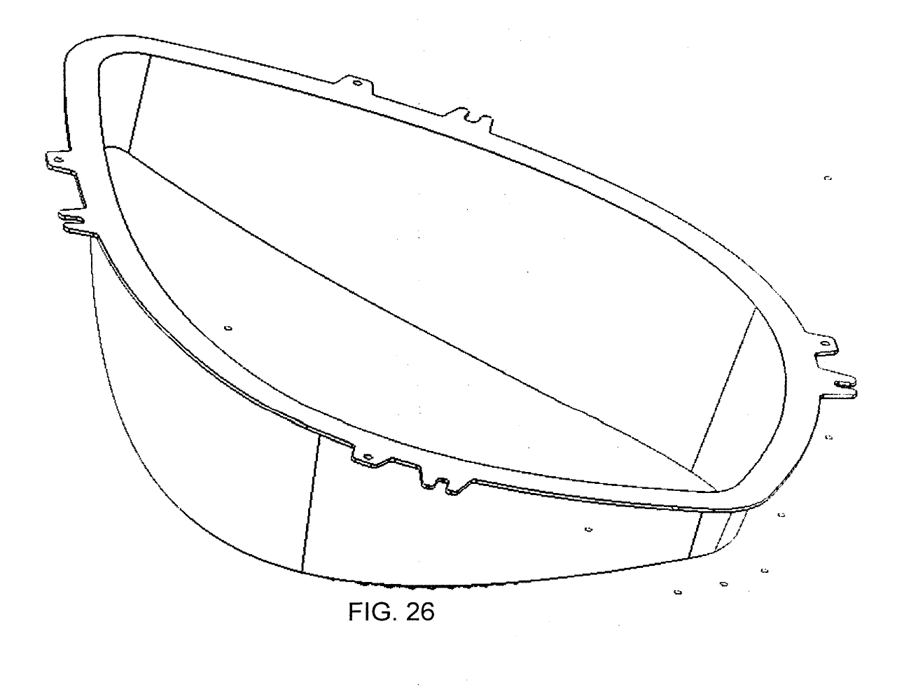

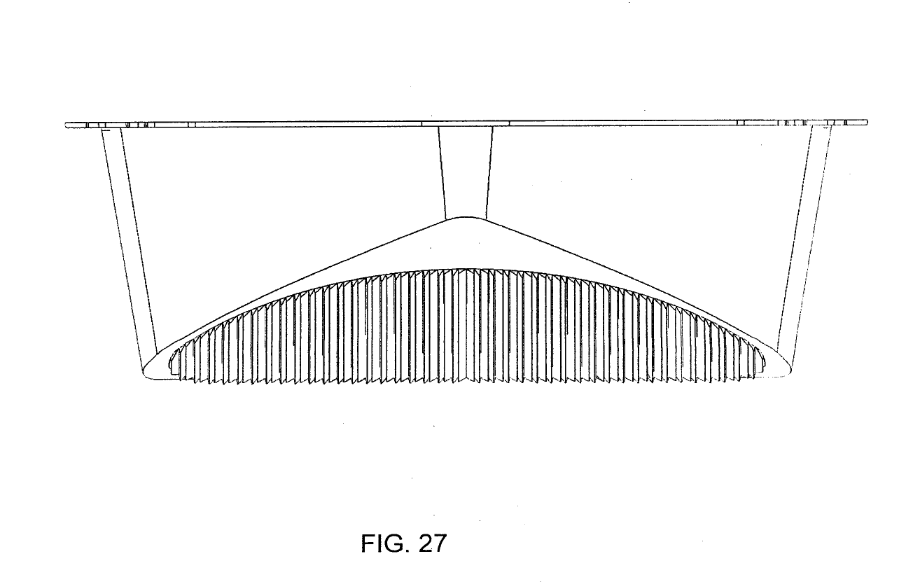

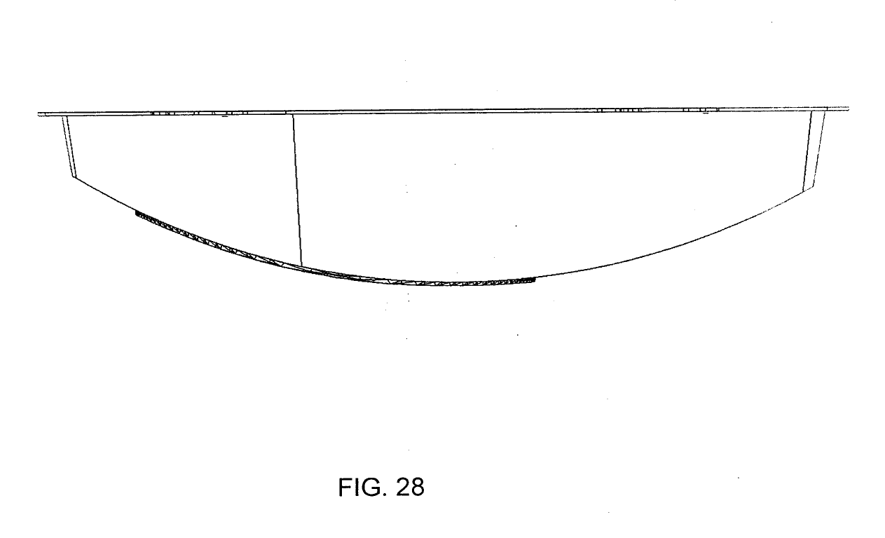

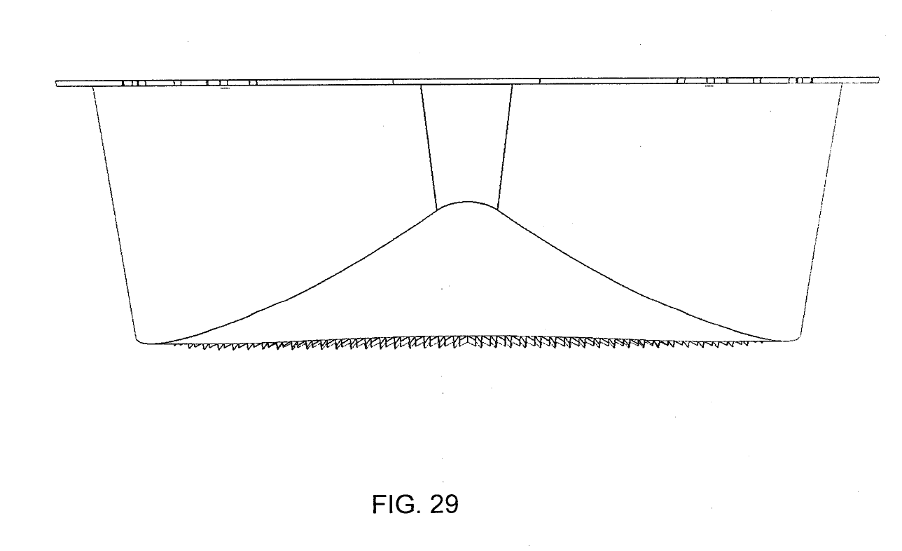

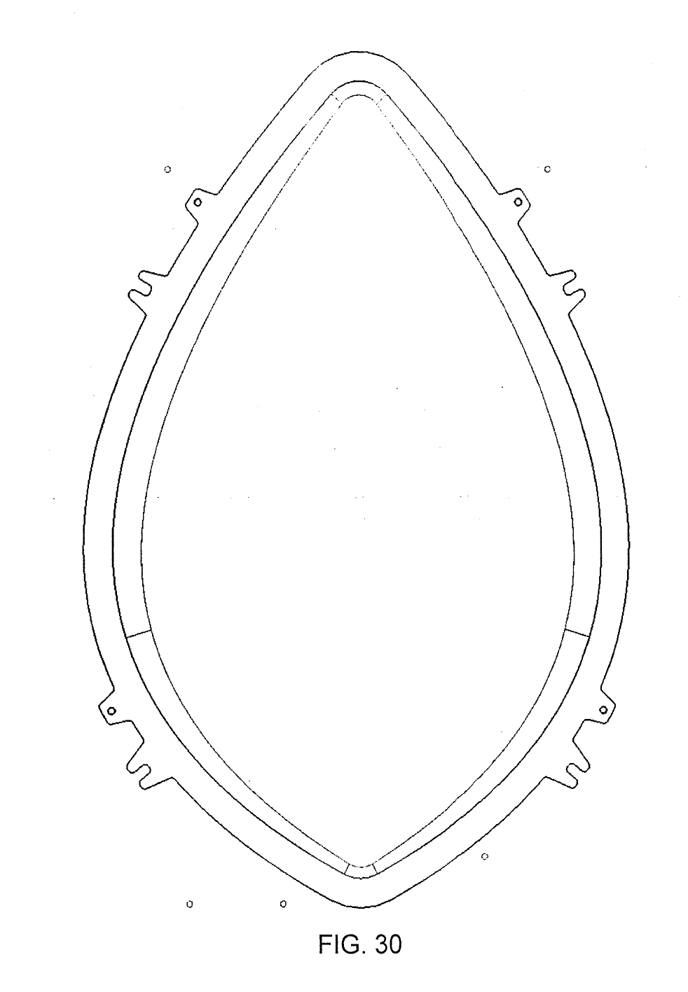

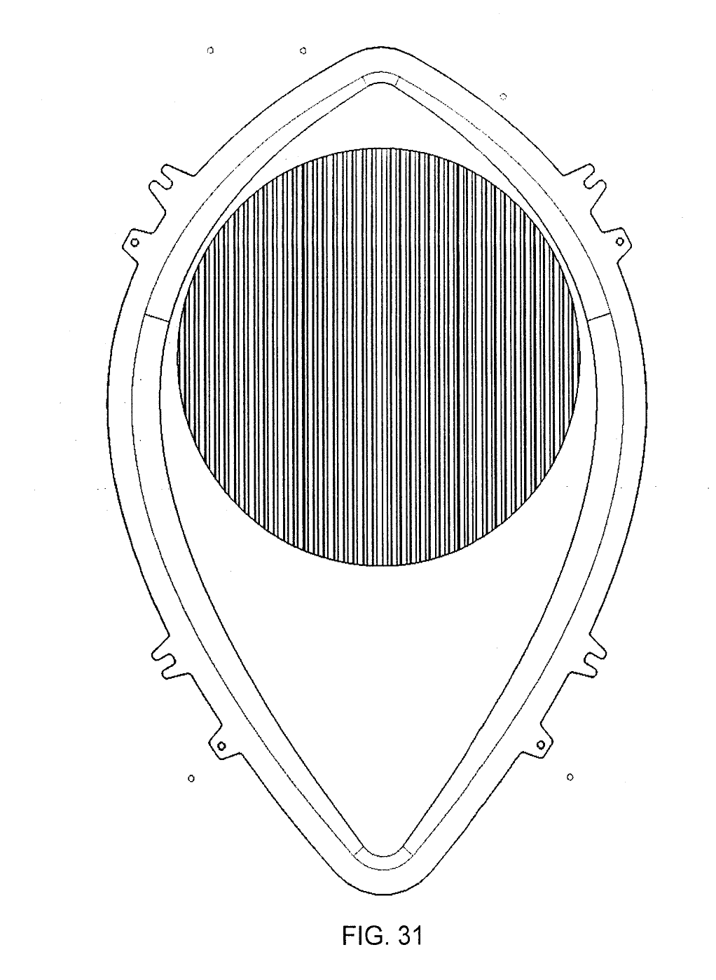

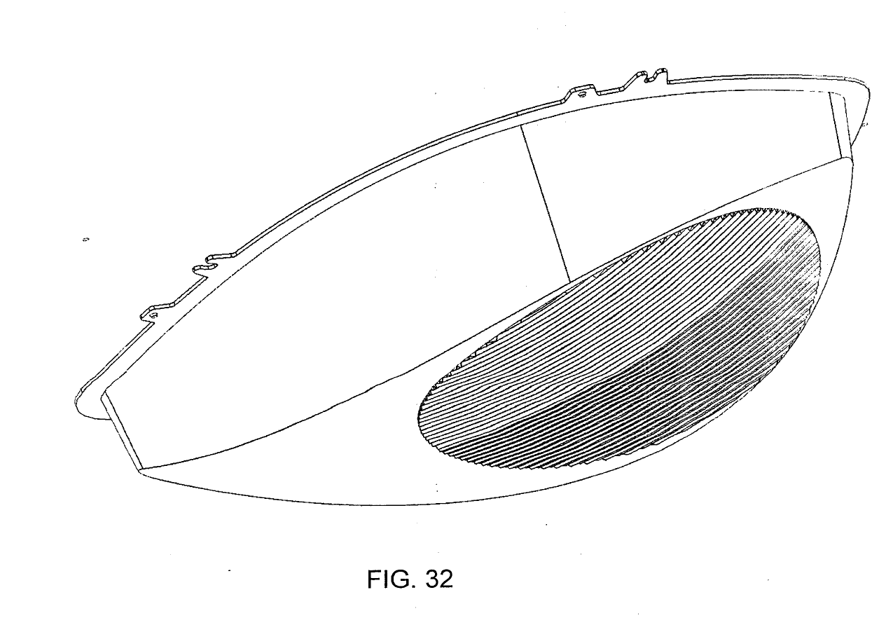

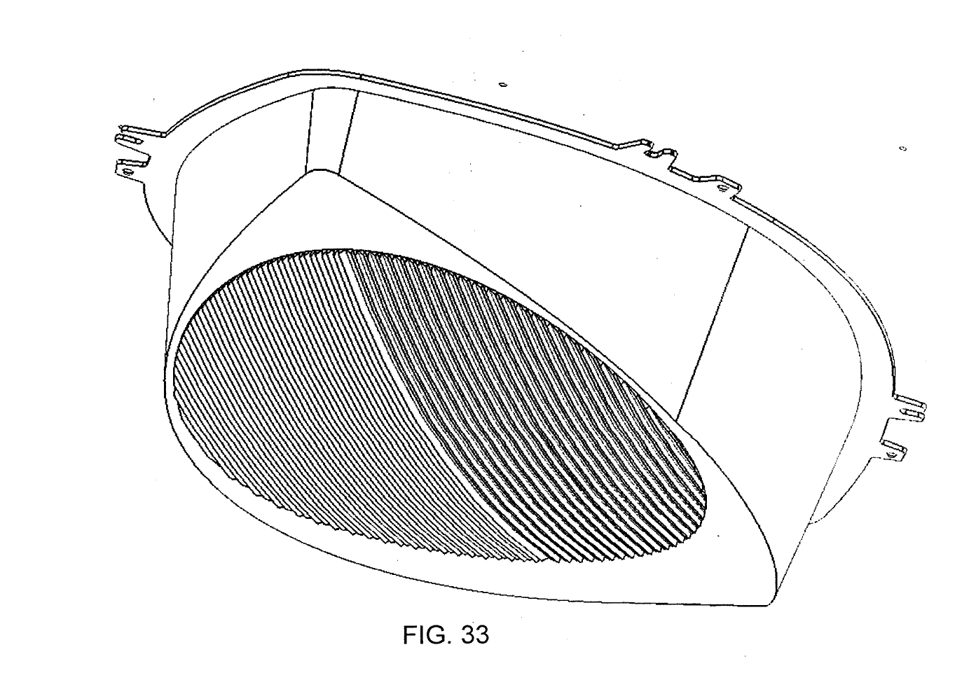

FIGS. 26-33 are right perspective, front elevation, right side elevation, rear elevation, top interior plan, bottom exterior plan, lower rear perspective, and lower front perspective views, respectively, of lens 206.

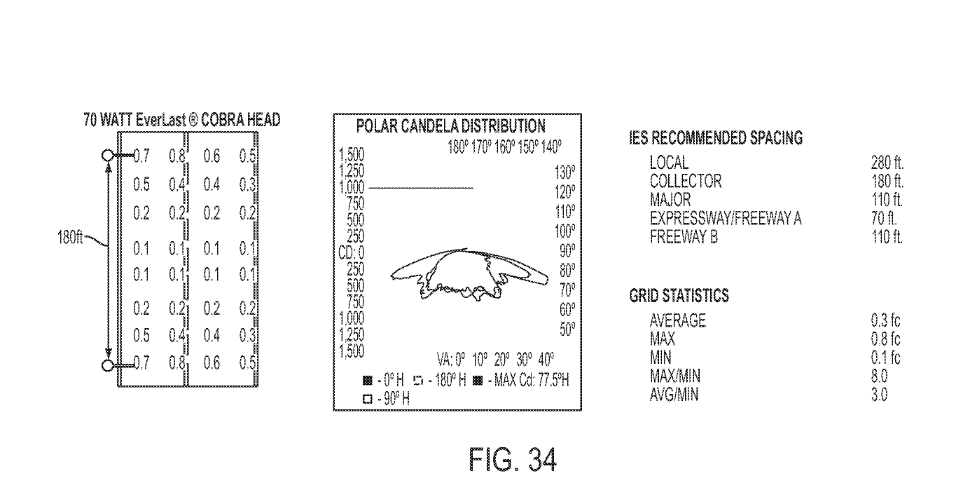

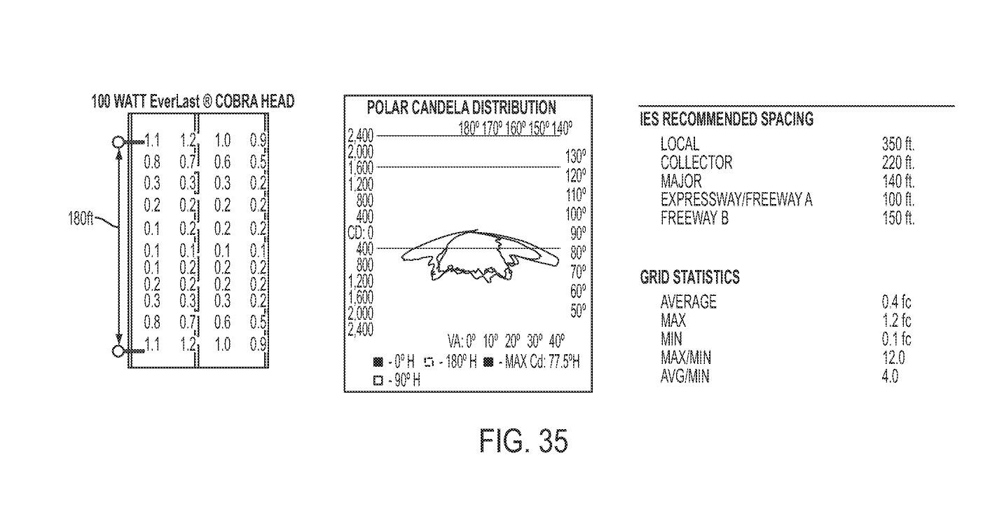

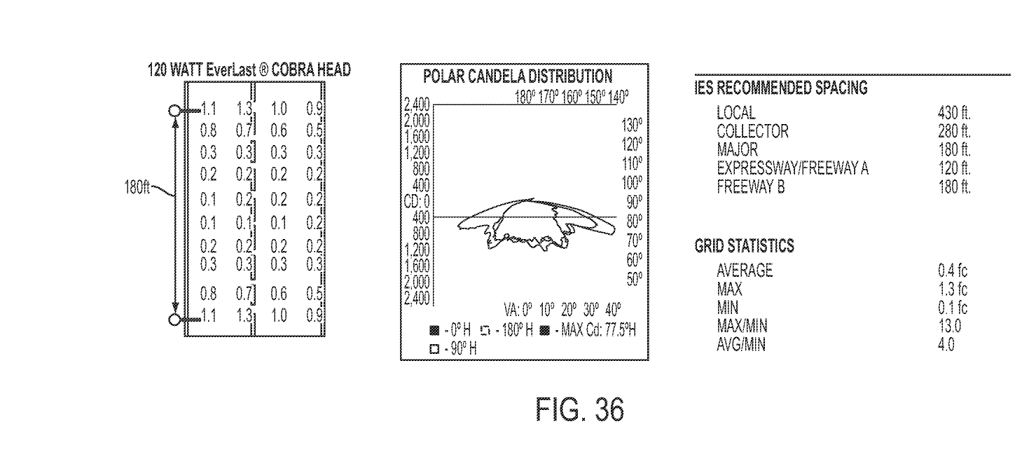

FIGS. 34-36 are data points and graphs corresponding to illumination levels of light fixture 200 for different wattage light sources, respectively, 70 Watt, 100 Watt, and 120 Watt. In at least some other embodiments, light fixture 200 comprises a light source wattage of 40, 55, or 80 watts.

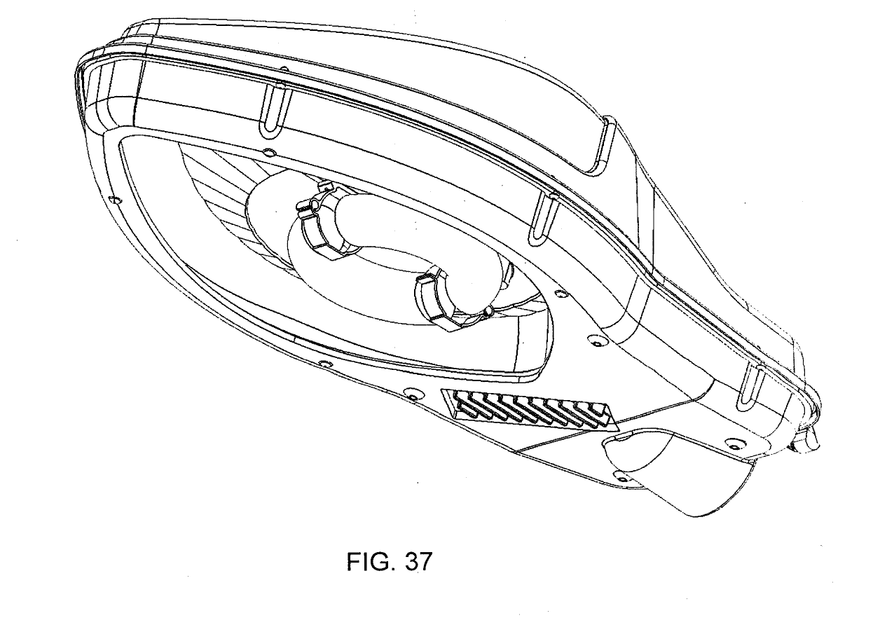

FIG. 37 depicts a right bottom perspective view of light fixture 200 with lens 206 removed.

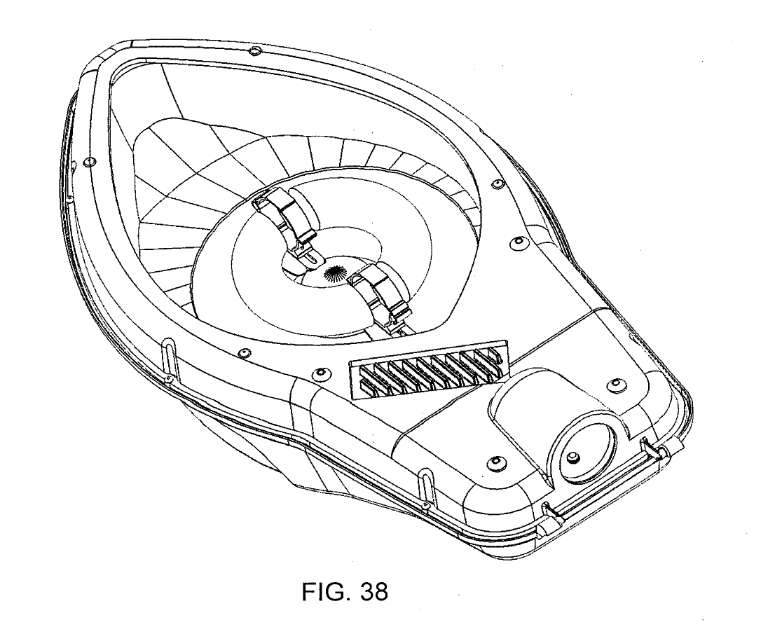

FIG. 38 depicts a rear bottom perspective view of light fixture 200 with lens 206 removed.

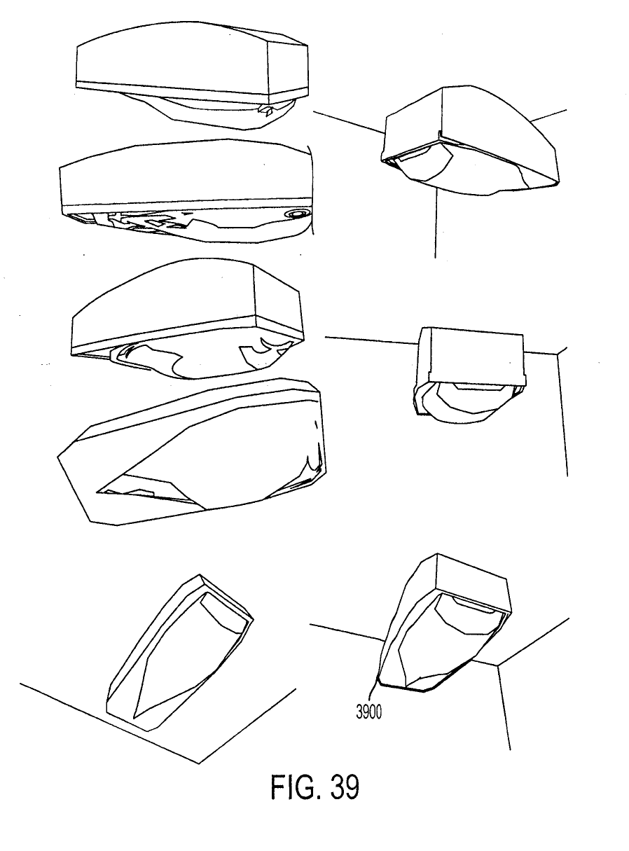

FIG. 39 depicts a collection of views of a shoebox head light fixture according to another embodiment. The shoebox head light fixture, in at least some embodiments, replaces light fixture 200 in connection with support pole 106 (FIG. 1).

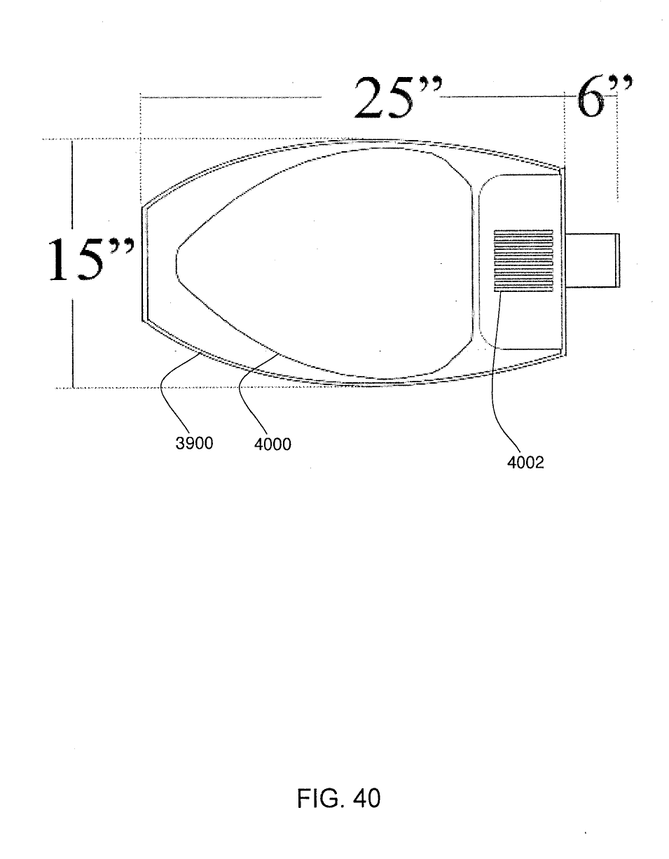

FIG. 40 depicts a bottom plan view of shoebox head light fixture 3900 of FIG. 39. Lens 4000 causes the distribution of illumination from light fixture 3900 and heat sink 4002 causes dissipation of heat from the unit.

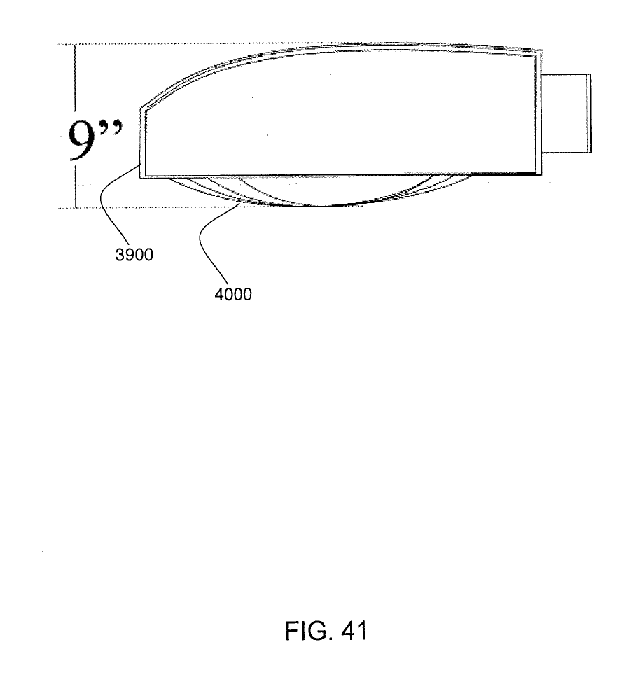

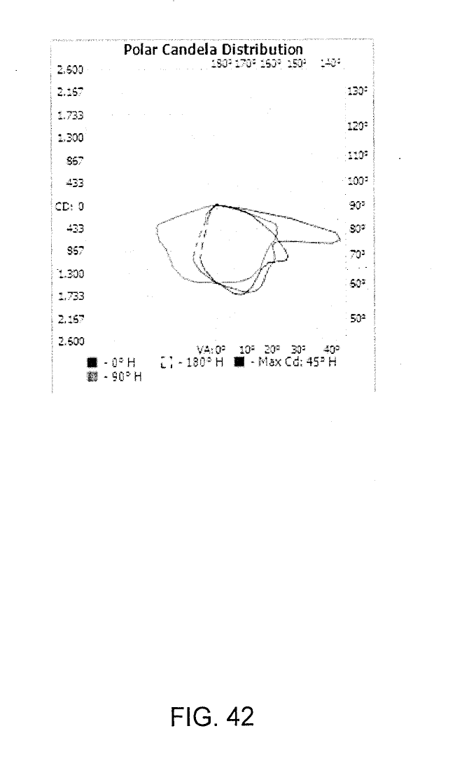

FIG. 41 depicts a side elevation view of shoebox head light fixture 3900 of FIG. 39 and FIG. 42 depicts a light illumination distribution graph of shoebox head light fixture 3900.

In at least some embodiments, light fixture 200 comprises a twist lock photocell for automatic on/off control of the light fixture.

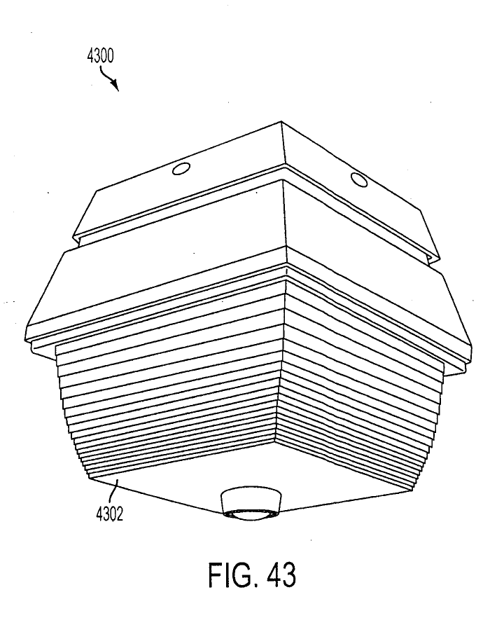

FIG. 43 is a side perspective view of a garage or canopy light fixture 4300 according to an embodiment. Garage light fixture 4300 comprises a lens 4302 having, in at least some embodiments, five sides for the distribution of illumination from the light fixture. In at least some embodiments, garage light fixture 4300 is coupled to a ceiling or overhead mounting mechanism.

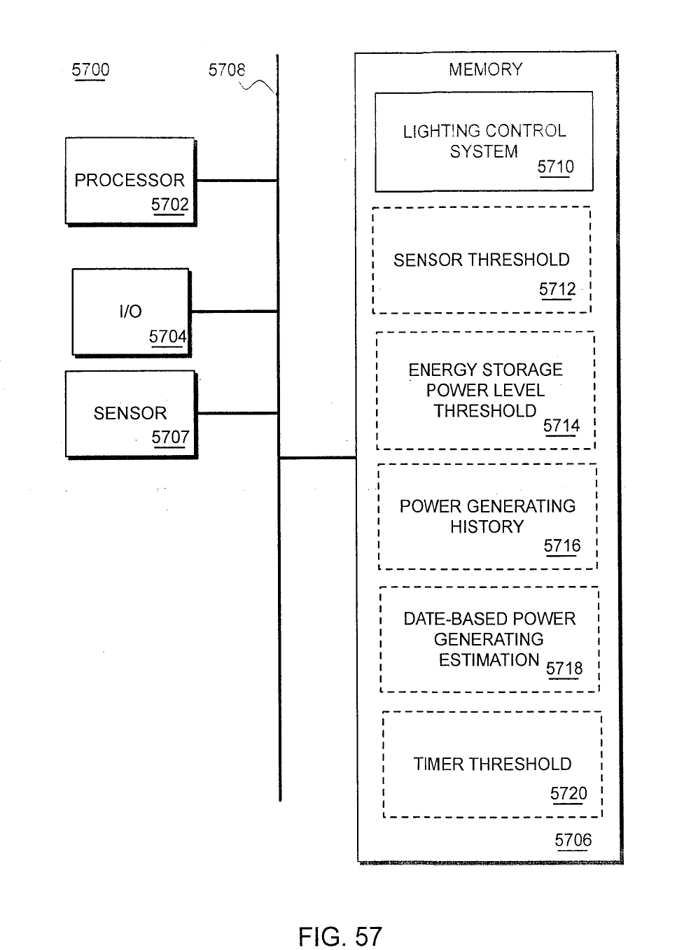

Light fixture 4300 also comprises a sensor 4304 positioned at a bottom of the light fixture. In at least some embodiments, sensor 4304 is a low-voltage, e.g., 24 volt, occupancy sensor. In at least some further embodiments, sensor 4304 comprises a gasketed removable lens for preventing and/or minimizing entry of water or other elements into the sensor interior. In at least some embodiments, sensor 4304 comprises a lens configured for an installation mounting height for peak (or optimized) performance as well as being at least partially masked for directional sensing. In at least some embodiments, sensor 4304 corresponds to sensor 5707 (FIG. 57).

As depicted light fixture 4300 also comprises an air gap 4306 between the top of the fixture (which in at least some embodiments houses a power source or ballast system) and a lamp chamber, e.g., a lower portion of the housing and/or lens 4302. Air gap 4306 prevents heat generated by an induction-based light source within light fixture 4300 from increasing the maximum power source, e.g., ballast, temperature and thus increases the expected life of the power source system, e.g., ballast.

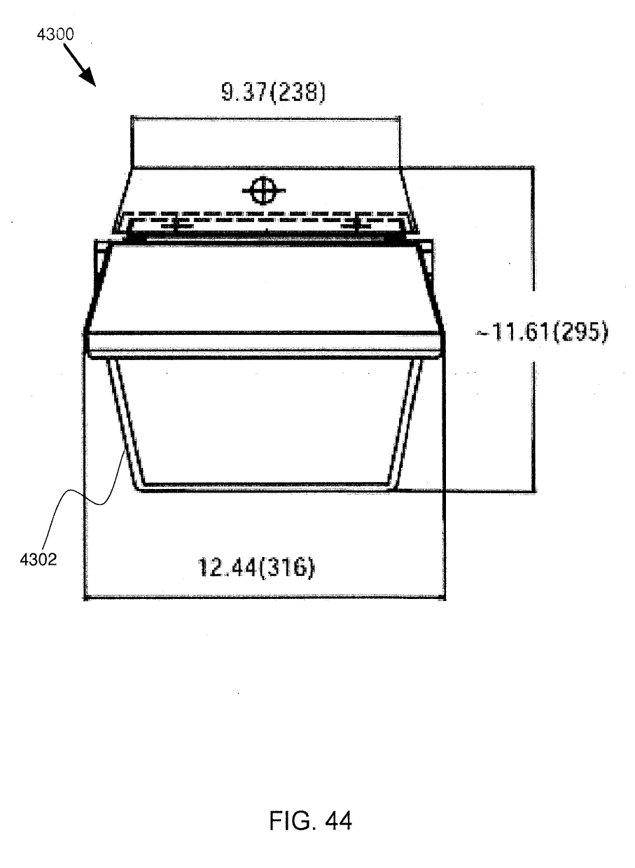

FIG. 44 is a side plan view of the garage or canopy light fixture 4300 (FIG. 43) depicting particular dimensions of the fixture in at least one embodiment.

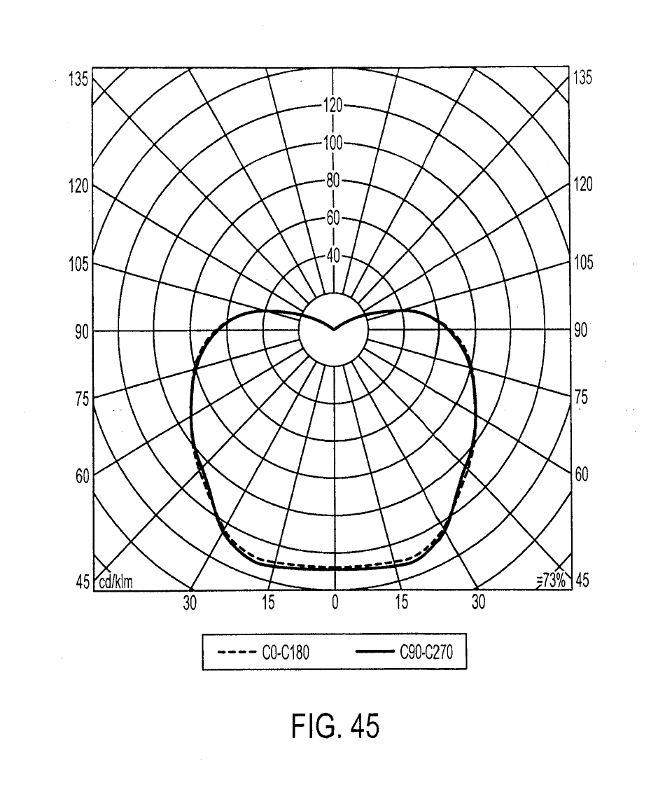

FIG. 45 is a depiction of a graph of the candle distribution of the garage light fixture 4300 (FIG. 43). The induction-based light source within light fixture 4300 is positioned vertically within lens 4302 to allow for a uniform Type IV distribution as seen in the polar candela graph of FIG. 45. In at least some embodiments, light source positioning with respect to an internal reflector and the lens is a critical determinant in creating a desired fixture light distribution type.

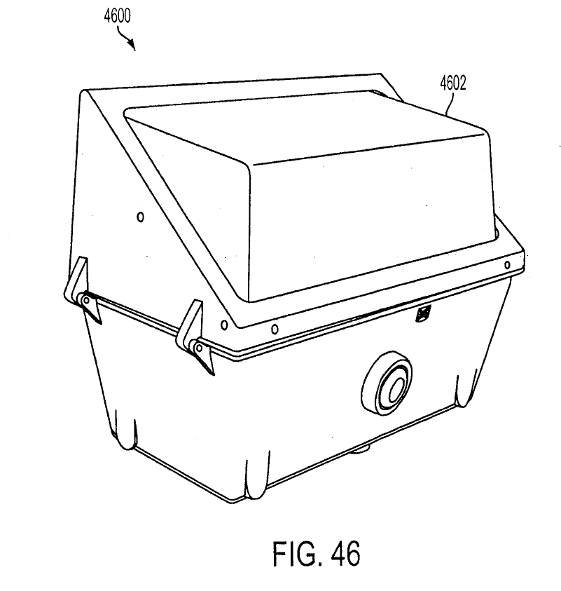

FIG. 46 is a side perspective view of a wall pack light fixture 4600 according to an embodiment. Wall pack light fixture 4600 comprises a lens 4602 having, in at least some embodiments, four sides for the distribution of illumination from the light fixture. In at least some embodiments, wall pack light fixture 4600 is coupled to a wall or other side mounting mechanism. In at least some embodiments, an induction-based light source within light fixture 4600 and an internal specular aluminum reflector are mounted at approximately a 45 degree angle within the fixture in order to maximize light output through the lens. Wall pack light fixture 4600 also comprises a sensor 4604 similar to sensor 4304 (FIG. 43).

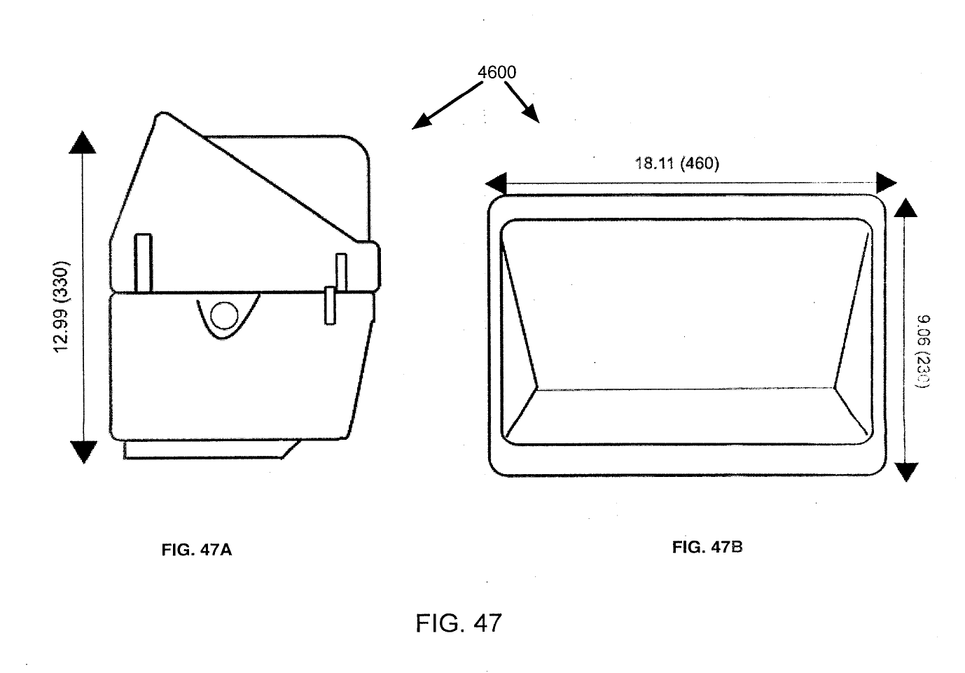

FIGS. 47A and 47B are side and top plan views, respectively, of the wall pack light fixture 4600 (FIG. 46) depicting particular dimensions of the fixture in at least one embodiment.

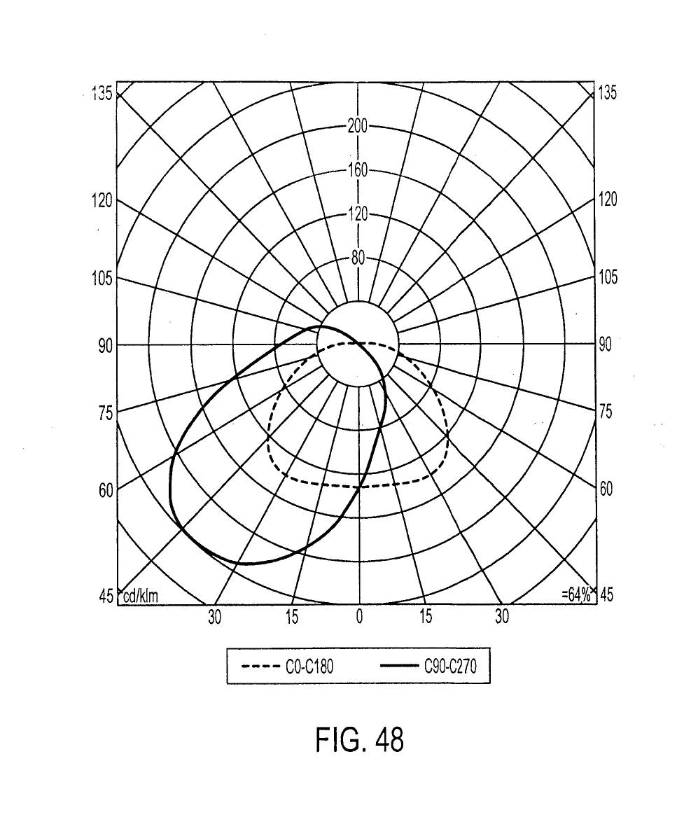

FIG. 48 is a depiction of a graph of the candle distribution of the wall pack light fixture 4600 (FIG. 46). Similar considerations apply as described above with respect to light fixture 4300.

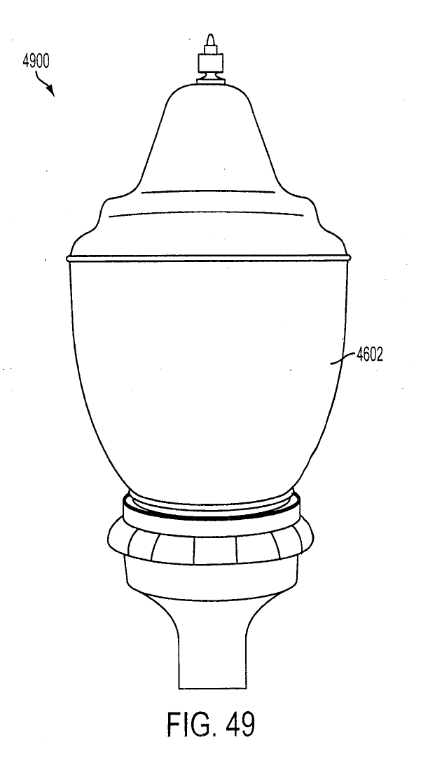

FIG. 49 is a side perspective view of a walkway light fixture 4900 according to an embodiment. Walkway light fixture 4900 comprises a lens 4902 having a circular horizontal cross section. In at least some embodiments, lens 4902 is comprised of two separate sections mated together. In at least some other embodiments, lens 4902 is formed of a single piece of translucent and/or transparent material.

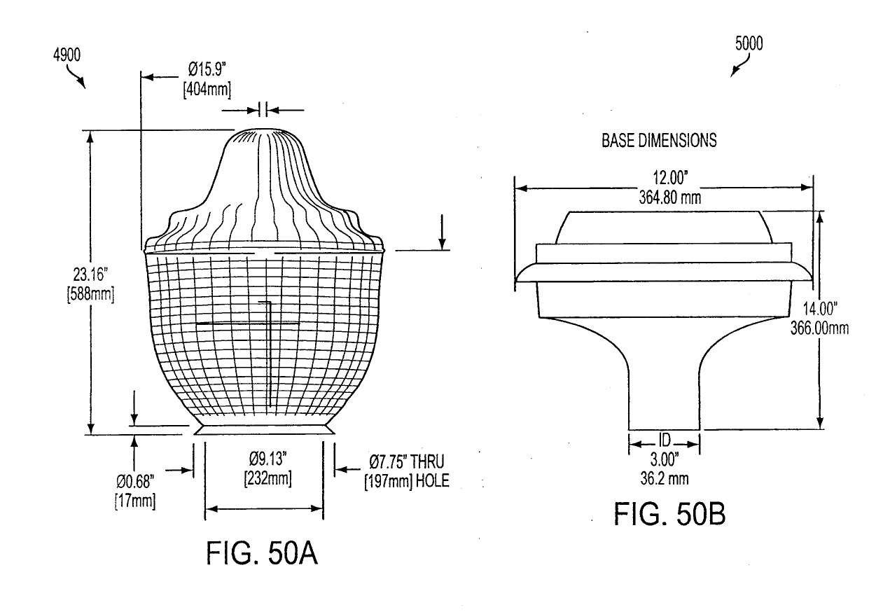

FIGS. 50A and 50B are side views of the light fixture 4900 (FIG. 49) and a base 5000 according to an embodiment for use with light fixture 4900. In use, fixture 4900 is coupled atop base 5000.

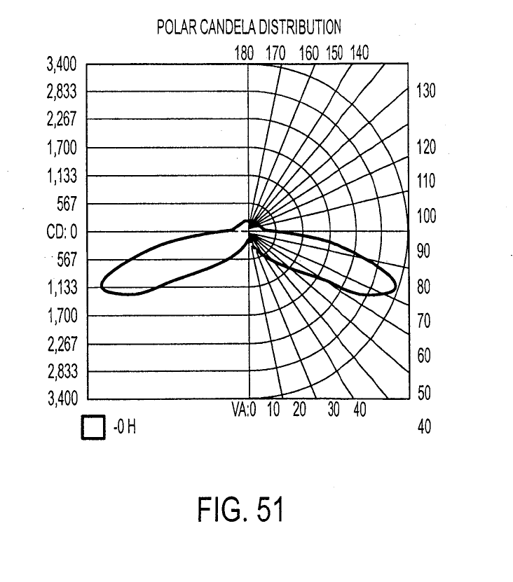

FIG. 51 is a depiction of a graph of the candle distribution of the walkway light fixture 4900 (FIG. 49) having Type V prismatic refractor optics. Type III distribution comprises a light fixture wherein the street side segment of the half-maximum-intensity iso intensity trace within the longitudinal range in which the point of maximum intensity falls lies partly or entirely beyond the 1.75× mounting height street side longitudinal roadway lines, but does not cross the 2.75× mounting height street side longitudinal roadway lines.

Type V distribution comprises a light fixture wherein the light distribution has a circular symmetry, being essentially the same at all lateral angles around the luminaire or light fixture.

Each light fixture comprises a specific refractor design to achieve a Type III or Type V distribution.

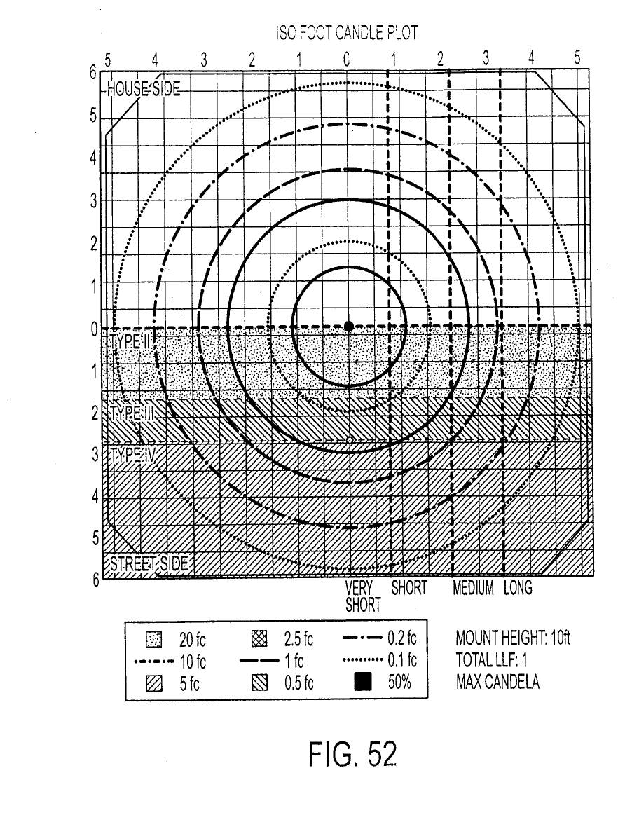

FIG. 52 is a depiction of a foot candle plot of the walkway light fixture 4900 (FIG. 49) having type V prismatic refractor optics.

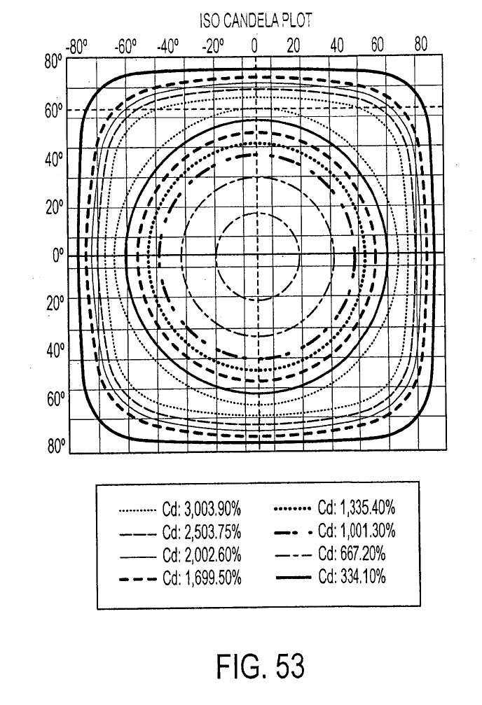

FIG. 53 is a depiction of a candela plot of the walkway light fixture 4900 (FIG. 49) having type V prismatic refractor optics.

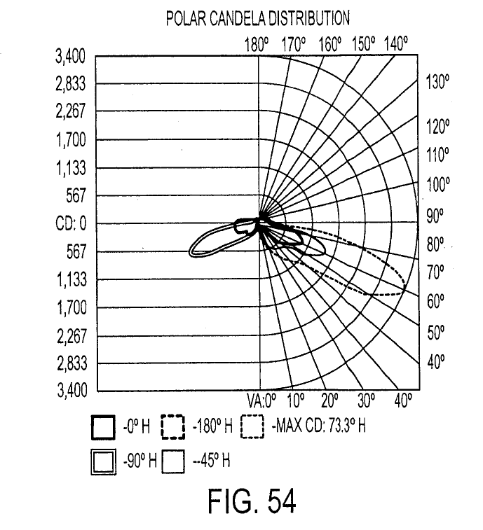

FIG. 54 is a depiction of a graph of the candle distribution of the walkway light fixture 4900 (FIG. 49) having type III prismatic refractor optics.

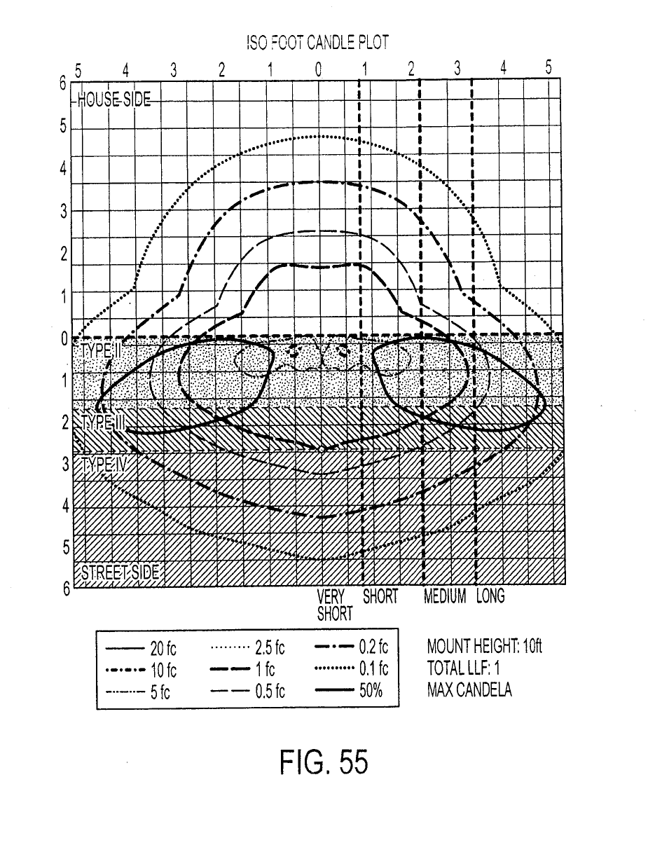

FIG. 55 is a depiction of foot candle plot of the walkway light fixture 4900 (FIG. 49) having type III prismatic refractor optics.

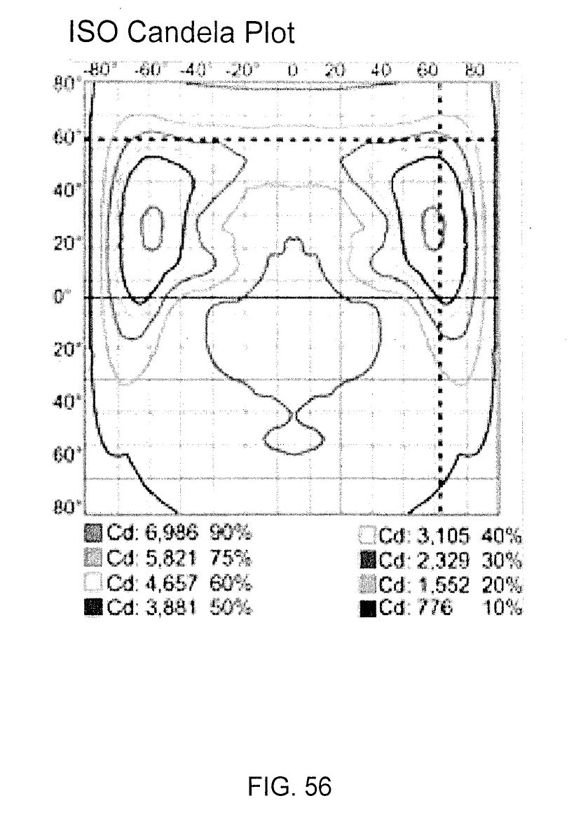

FIG. 56 is a depiction of candela plot of the walkway light fixture 4900 (FIG. 49) having type III prismatic refractor optics.

FIG. 57 depicts a high-level functional block diagram of a controller 5700 usable in conjunction with an embodiment, e.g., as controller 5800 or as a controller integrated as part of a light fixture such as the cobra head, garage, wall pack, or walkway light fixtures. Controller 5700 comprises a processor or controller-based device 5702, an input/output (I/O) device 5704, a memory 5706, and a sensor 5707 each communicatively coupled with a bus 5708. Memory 5706 (which may also be referred to as a computer-readable medium) is coupled to bus 5708 for storing data and information and instructions to be executed by processor 5702. Memory 5706 also may be used for storing temporary variables or other intermediate information during execution of instructions to be executed by processor 5702. Memory 5706 may also comprise a read only memory (ROM) or other static storage device coupled to bus 5708 for storing static information and instructions for processor 5702. Memory 5706 may comprise static and/or dynamic devices for storage, e.g., optical, magnetic, and/or electronic media and/or a combination thereof.

I/O device 5704 may comprise a display, such as a cathode ray tube (CRT) or a flat panel display or other illuminating devices such as illuminated icons or pre-arranged light emitting diodes, for displaying information, alphanumeric and/or function keys for communicating information and command selections to the processor 5702, a cursor control device, such as a mouse, a trackball, or cursor direction keys for communicating direction information and command selections to the processor and for controlling cursor movement on the display, or a combination thereof. This input device typically has two degrees of freedom in two axes, a first axis (e.g., x) and a second axis (e.g., y) allowing the device to specify positions in a plane. In at least some embodiments, I/O device 5704 is optional.

Sensor 5707 generates a motion and/or occupancy detection signal responsive to detection of motion and/or occupancy by living beings within a predetermined area adjacent lighting device 100. In at least some embodiments, sensor 5707 is a motion sensor positioned to detect movement within the predetermined area. In at least some embodiments, sensor 5707 is an occupancy sensor positioned to detect occupancy by living beings within the predetermined area. In at least some embodiments, sensor 5707 generates radio frequency emissions, e.g., infrared and/or microwave or other emissions, toward the predetermined area and generates the detection signal in response to changes detected in return signals from the predetermined area. Sensor 5707 generates the detection signal for use by lighting control system 5710 during execution by processor 5702.

Memory 5706 comprises a lighting control system 5710 according to one or more embodiments for determining illumination of induction-based light fixture 108 (FIG. 1). Lighting control system 5710 comprises one or more sets of instructions which, when executed by processor 5702, causes the processor to perform particular functionality. In at least some embodiments, lighting control system 5710 determines how long light fixture 108 should be illuminated based on at least signals, e.g., information and/or data, received from sensor 5707 such as an occupancy and/or motion sensor, coupled to the controller.

In at least some further embodiments, lighting control system 5710 determines when and/or how long light fixture 108 should be illuminated based on a monitored power level of an energy storage device, monitored power generating patterns, e.g., with respect to one or both of solar panels and/or wind turbines, and/or a date-based information, or a combination thereof.

In at least one embodiment, lighting control system 5710 determines if light fixture 108 should be illuminated responsive to receipt of a motion/occupancy detection signal from sensor 5707. Lighting control system 5710 determines if light fixture 108 should be illuminated based on comparing the detection signal value (if applicable) with a sensor threshold value 5712 stored in memory 5706. If the detection signal value meets or exceeds the sensor threshold value 5712, control system 5710 causes activation of light fixture 108.

In at least some embodiments, sensor threshold value 5712 may specify one or more different threshold values. In accordance with such an embodiment, if the detection signal exceeds a lowest threshold value and not a next higher threshold value, light fixture 108 may be activated at a reduced or dimmed illumination level. If the detection signal exceeds each of the threshold values, light fixture 108 may be activated at a full illumination level.

In at least some embodiments, lighting control system 5710 executes a timer function in conjunction with monitoring for the detection signal in order to dim the illumination level of lighting device 100 during periods of inactivity in the predetermined area adjacent the lighting device. For example, if the timer has exceeded a predetermined inactivity threshold value 5720 (stored in memory 5706), lighting control system 5710 causes light fixture 108 to reduce the illumination level to a dimmed level, e.g., a predetermined percentage of the full output level of the device. In at least some embodiments, lighting control system 5710 resets or restarts timer responsive to receipt of a detection signal from sensor 5707.

In at least one embodiment, lighting control system 5710 determines how long light fixture 108 should be illuminated based on comparing an energy potential stored in an energy storage device with an energy storage power level threshold 5714 stored in memory 5706. In at least some embodiments, energy storage power level threshold 5714 comprises a set of values corresponding to different durations in which light fixture 108 may be illuminated. For example, at a first threshold level, controller 5700 may cause light fixture 108 to illuminate for 4 hours, at a second lower threshold level, the controller may cause the light source to illuminate for 2 hours, etc. In at least some embodiments, energy storage power level threshold 5714 comprises a single value above which the energy storage power level must exceed in order for controller 5700 to cause the light source to illuminate. The energy storage power level threshold 5714 may be predetermined and/or user input to controller 5700.

In at least one embodiment, lighting control system 5710 determines how long light fixture 108 should be illuminated based on comparing a power generating history 5716 stored in memory 5706. Power generating history 5716 may comprise a single value or a set of values corresponding to a time and/or date based history of the power generated by one or both or each of solar panels and wind turbines. For example, lighting control system 5710 may apply a multi-day moving average to the power generating history of one or both or each of solar panels and wind turbines in order to determine the power generating potential for subsequent periods and estimate based thereon the amount of power which may be expended to illuminate light fixture 108 during the current period. In at least one embodiment, lighting control system 5710 applies a three (3) day moving average to the power generating history of one or both of solar panels and wind turbines.

In at least one embodiment, lighting control system 5710 determines how long light fixture 108 should be illuminated based on a date-based power generating estimation 5718 stored in memory 5706. For example, depending on a geographic installation location of lighting device 100 (FIG. 1), controller 5700 may determine the illumination of light fixture 108 based on a projected amount of daylight for the particular location, e.g., longer periods of darkness during winter in Polar locations as opposed to Equatorial locations. In at least some further embodiments, controller 5700 may be arranged to cause illumination of light fixture 108 for a predetermined period of time based on information from one or more of energy storage power level threshold 5714, power generating history 5716, and/or date-based power generating estimation 5718 and after termination of the predetermined period be arranged to cause illumination of the light source responsive to a signal from a motion sensor for a second predetermined period of time.

In at least some further embodiments, lighting control system 5710 determines when light fixture 108 should be illuminated based on receipt of a signal from an occupancy or traffic detector, e.g., a motion sensor operatively coupled with controller 5700.

In at least some embodiments, controller 5700 also comprises an electrical connection to a mains power supply. The mains power supply connection may be used in a backup/emergency situation if neither of the solar panels, wind turbine, or energy storage device are able to supply sufficient power levels to power light fixture 108. In another embodiment, the mains power supply connection may be used to return power generated by lighting device 100 to a power supply grid. In at least some embodiments, the returned electric power may be returned for free or for a predetermined price.

In at least some embodiments, controller 5700 regulates the supply of electricity to light fixture 108. By regulating the supplied electricity, controller 5700 may prevent and/or minimize unexpected spikes or drops in the supplied electricity level to light fixture 108. In at least some embodiments, controller 5700 may also direct from which component light fixture 108 receives electricity, e.g., energy storage device or directly from wind turbine, solar panels, etc.

In at least some embodiments, controller 5700 also comprises a light sensor to determine if a predetermined threshold has been met in order to transfer electricity to light fixture 108 to cause the light source to activate and generate illumination. In at least some alternate embodiments, light fixture 108 comprises the light sensor. The light sensor is a switch controlled by a detected light level, e.g., if the light level is below a predetermined threshold level, the switch is closed and electricity flows to light fixture 108.

FIG. 58 depicts a side view of a street lamp having a cobra head light fixture according to another embodiment including a controller 5800 connected to the street lamp for controlling the lamp.

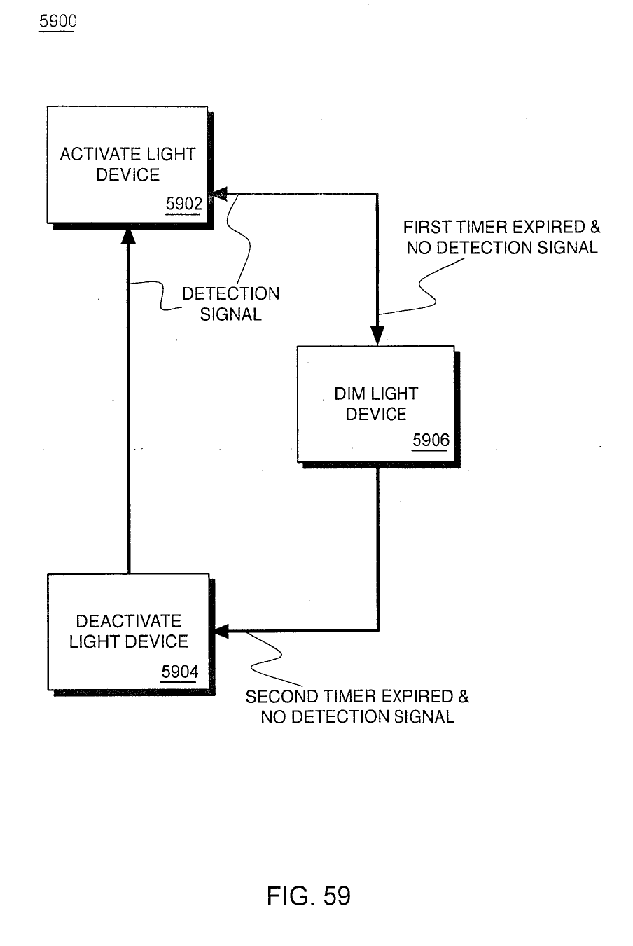

FIG. 59 depicts a high-level functional process flow 5900 of at least a portion of lighting control system 5710 according to an embodiment.

The process flow begins at either activate light device functionality 5902 or deactivate light device functionality 5904. In at least some embodiments, upon powering up of lighting device 100, the device automatically begins operation in an active or illuminated state corresponding to activate light device functionality 5902. In at least some other embodiments, device 100 automatically begins operation in a dark or non-illuminated state corresponding to deactivate light device functionality 5904.

Given a starting state of activate light device functionality 5902, after expiration of a first timer set by control system 5710 (FIG. 57), which in at least some embodiments inherently means that no detection signal has been received from sensor 5707, the flow of control proceeds to dim light device functionality 5906. During execution of dim light device functionality 5906, control system 5710 causes light source 108 to dim or reduce the illumination level provided to the area adjacent lighting device 100 by a predetermined amount.

In response to receipt of a detection signal from sensor 5707 (indicative of either motion and/or occupancy in the predetermined area adjacent lighting device 100), the flow of control returns to activate light device functionality 5902.

If a detection signal from sensor 5707 is not received during dim light device functionality 5906 execution and a second timer expires, the flow of control proceeds to deactivate light device functionality 5904. During execution of device light functionality 5904, lighting control system 5710 execution causes light fixture 108 to cease illuminating, i.e., turn off the light source. Similar to dim light device functionality 5906, in response to receipt of a detection signal from sensor 5707, the flow of control returns to activate light device functionality 5902.

In at least some embodiments, the above-described fixtures are installed in exterior applications, i.e., exterior to a building or other enclosed structure. For example, the lighting device 100 may be installed along a walkway or path along which individuals move. In at least some embodiments, lighting device 100 is installed in exterior applications to the exclusion of interior applications. That is, in at least some embodiments, lighting device 100 is not installed within a building or other enclosed structure.

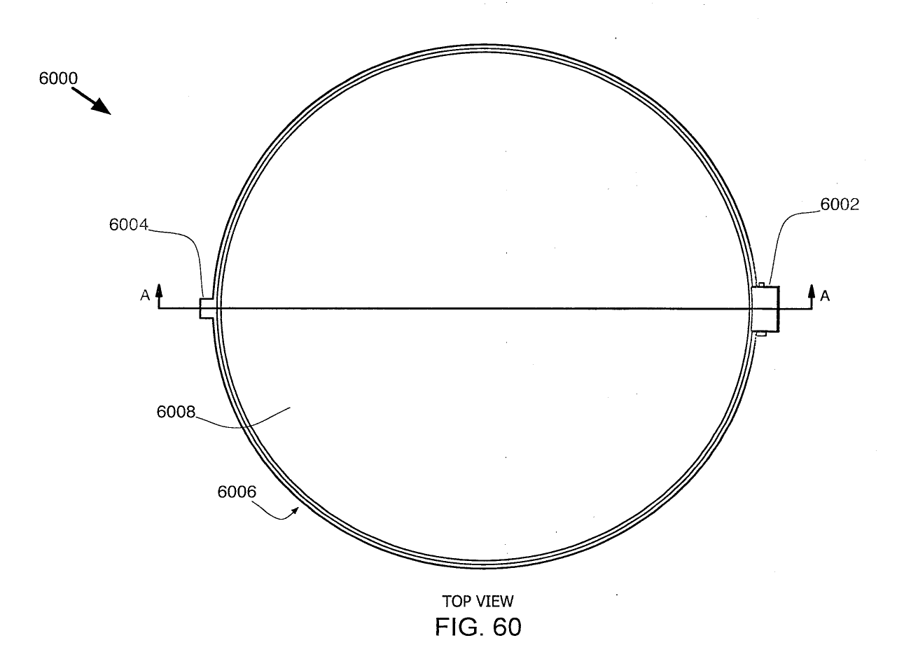

FIG. 60 is a top plan view of an induction-based light fixture 6000 according to another embodiment. Light fixture 6000 comprises a hinge 6002 coupled to a perimeter of the fixture for enabling access to a power source, e.g., a ballast, mounted in the base of the light fixture. Light fixture 6000 also comprises a latch 6004 or other closure or retention mechanism at an opposing side of the perimeter of the light fixture from hinge 6002 for retaining the light fixture lens in a closed position. Light fixture 6000 also comprises a lens 6006 positioned and configured to direct luminance generated by the induction-based light source toward a predetermined area adjacent lighting device 100 (FIG. 1). In at least some other embodiments, light fixture 6000 comprises different opening and/or closing mechanisms for providing access to the enclosed light source. In at least some other embodiments, the opening and/or closing mechanism is usable to gain access to the induction-based light source within light fixture 6000.

Light fixture 6000 is depicted such that a base 6008 of the light fixture is visible in FIG. 60. In at least some embodiments, base 6008 is usable to mount light fixture 6000 to a ceiling or other support mechanism for the light fixture.

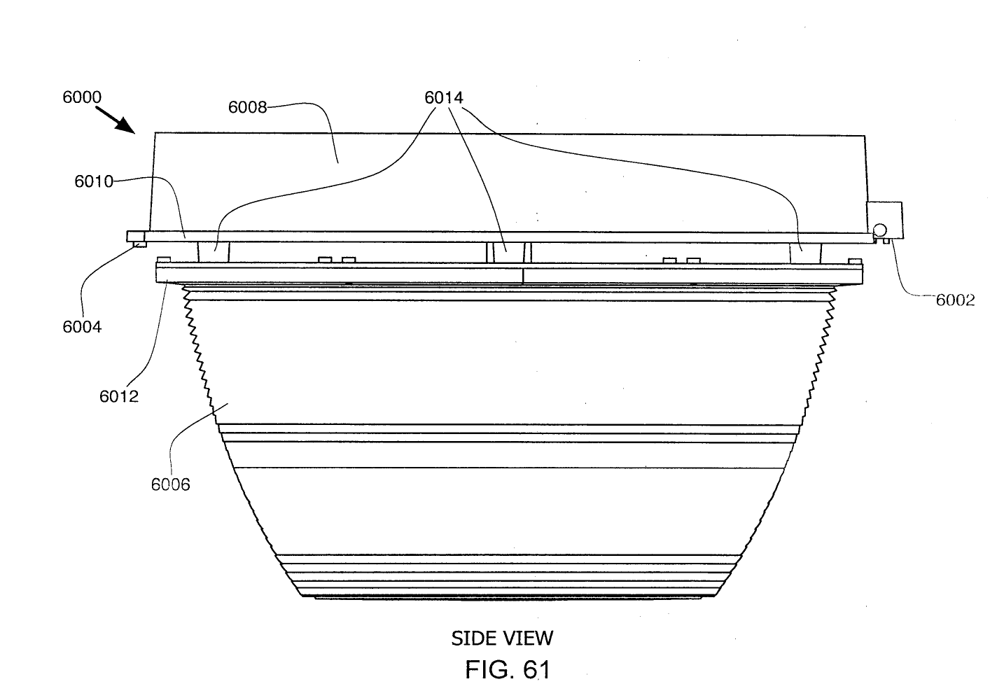

FIG. 61 is a side view of the light fixture of FIG. 60 including lens 6006. Lens 6006 is generally a segmented or flat-topped conical shape in form. As depicted light fixture 6000 further comprises a base mounting plate 6010 for enclosing base 6008 and providing, in cooperation with hinge 6002 and latch 6004 access to the interior of the base. Light fixture 6000 further comprises a lens mounting plate 6012 to which lens 6006 is coupled and, in turn, which is coupled to base mounting plate 6010 via spaced connecting segments 6014. In at least some embodiments, lens mounting plate 6012 and lens 6006 are coupled via one or more arcuate mounting segments circumferentially spaced about the perimeter of the lens and the lens mounting plate. In at least some embodiments, there are three mounting segments which each comprise an interior channel for retaining a perimeter edge of lens 6006 in contact with an edge of lens mounting plate 6012.

In at least some embodiments, mounting segments 6014 are of a length sufficient to enable dispersion of heat generated by either a power source in base 6008 or the induction-based light source within lens 6006. In at least some embodiments, greater or fewer number of mounting segments 6014 are used.

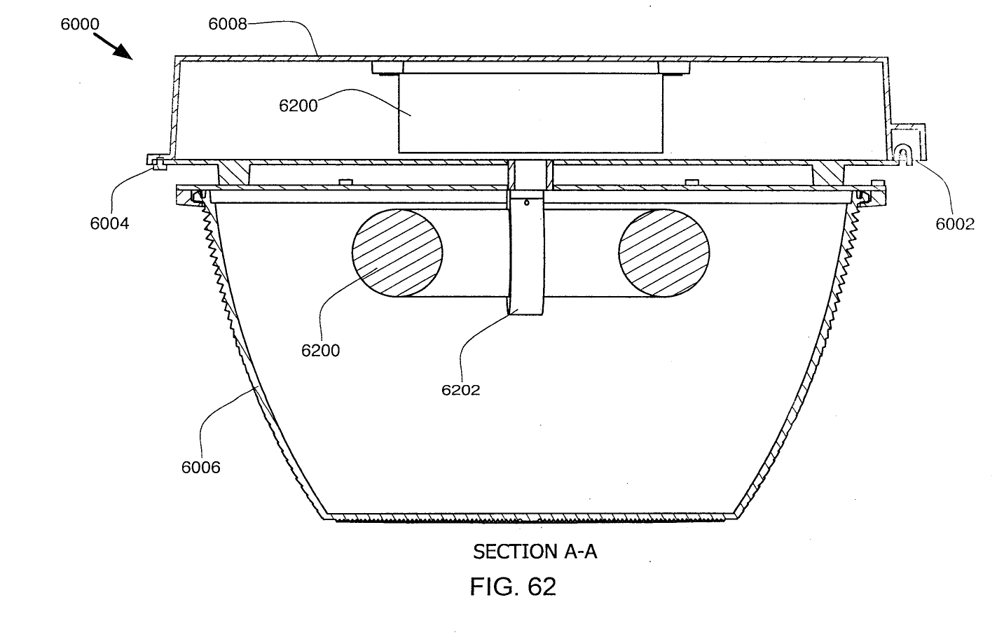

FIG. 62 is a side section view of the light fixture of FIG. 60 depicting a power source 6200 positioned within base 6008 and an induction-based light source 6200 positioned within lens 6006. Additionally, a retention coil 6202 is depicted within lens 6006 and surrounding light source 6200. For simplicity, electrical connections between retention coil 6202 and power source 6200 and between power source 6200 and mains or other power supply is not shown.

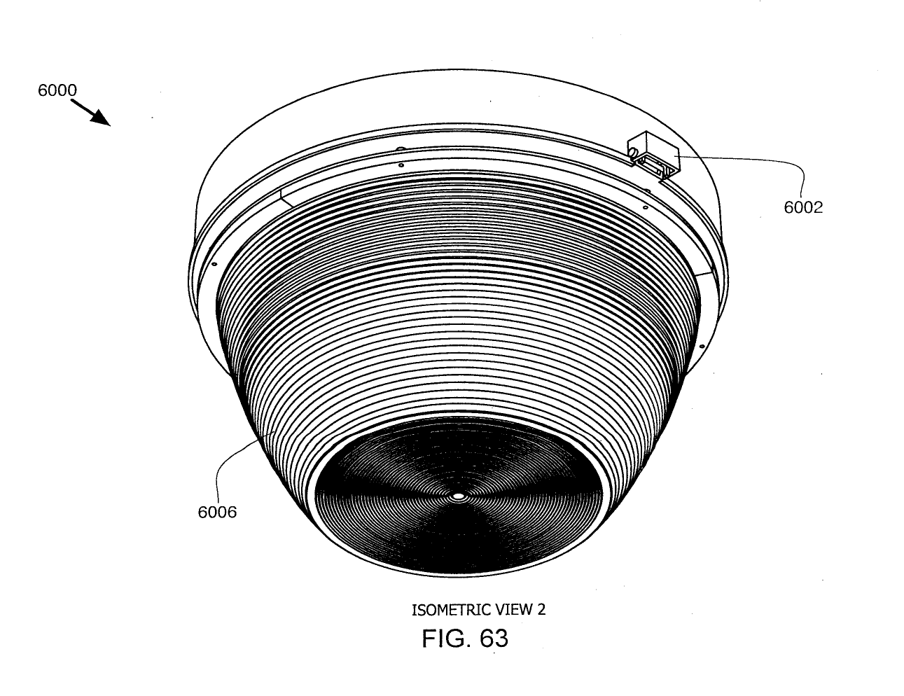

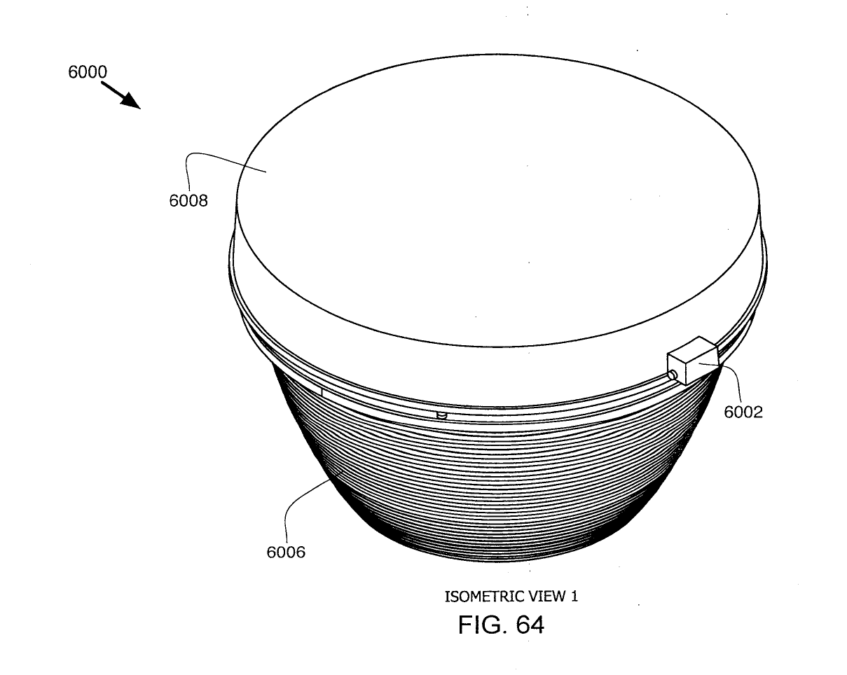

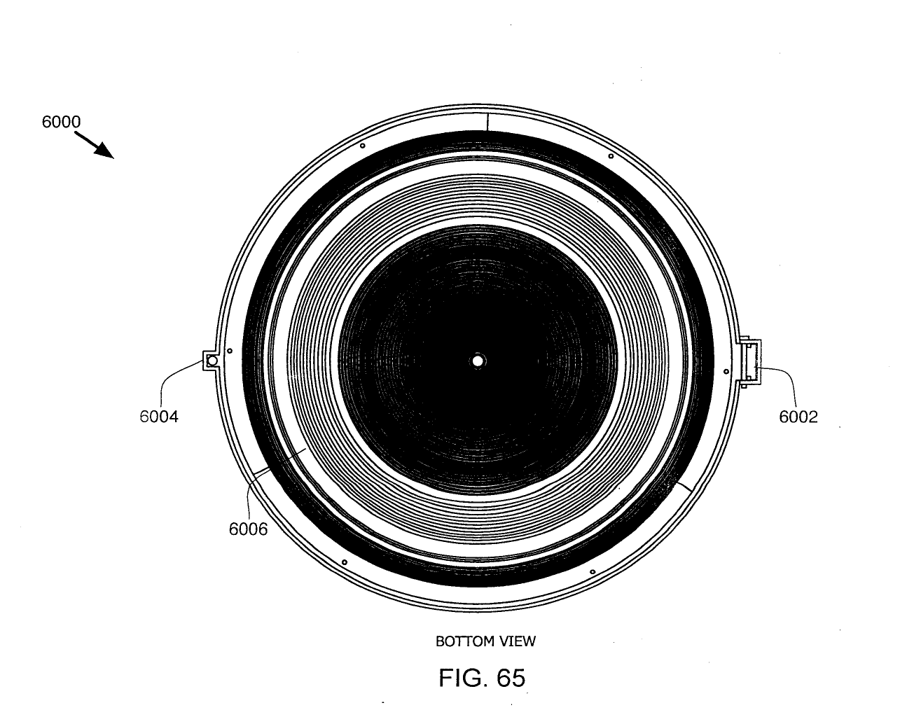

FIG. 63 is an isometric view of light fixture 6000 of FIG. 60. FIG. 64 is an other isometric view of light fixture 6000 of FIG. 60. FIG. 65 is a bottom view of light fixture 6000 of FIG. 60.

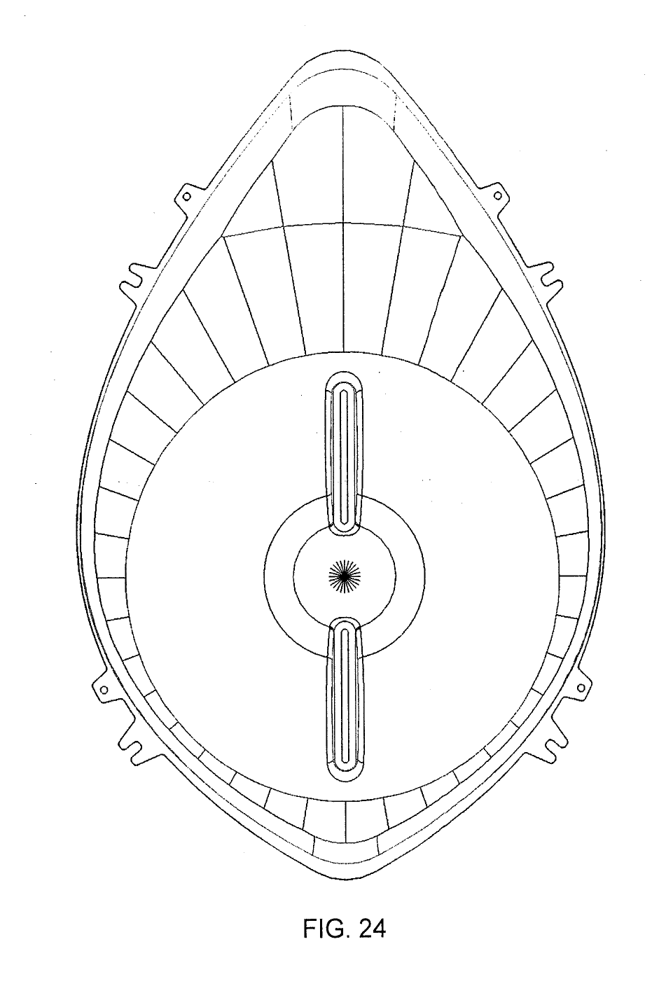

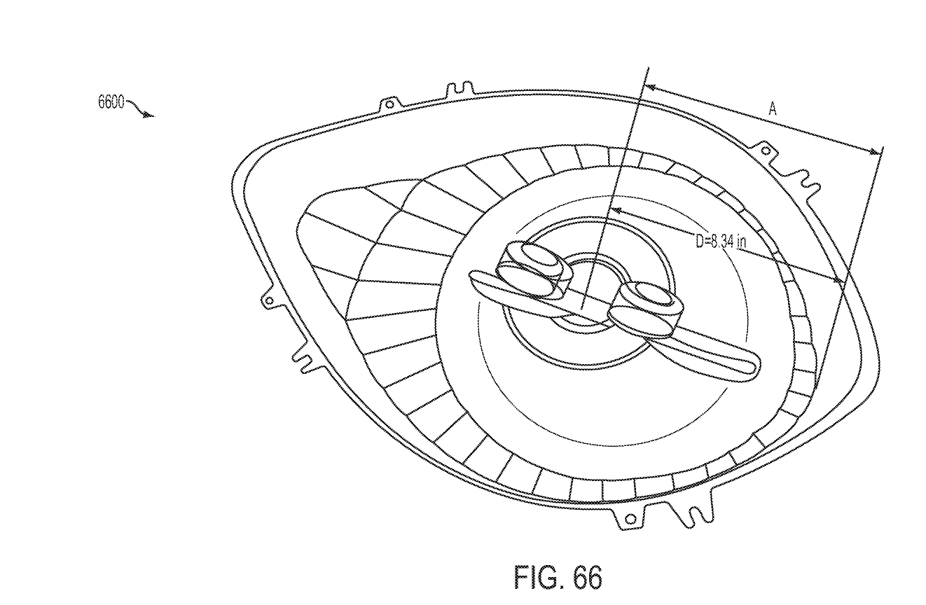

FIG. 66 is a perspective view of a cobra head light fixture reflector 6600 according to an embodiment similar to FIG. 24. As depicted reflector 6600 is configured for a 40 Watt induction-based light source having a circular cross-section tubular arrangement. The distance A between an inner edge of reflector 6600 and the center of the induction-based light source is 8.34 inches to achieve a desired illumination distribution. In at least some embodiments, the combination of the reflector 6600 design depicted and a 40 Watt induction-based light source arranged as depicted results in an optimal illumination distribution. In at least some other embodiments, greater or smaller dimensions are used.

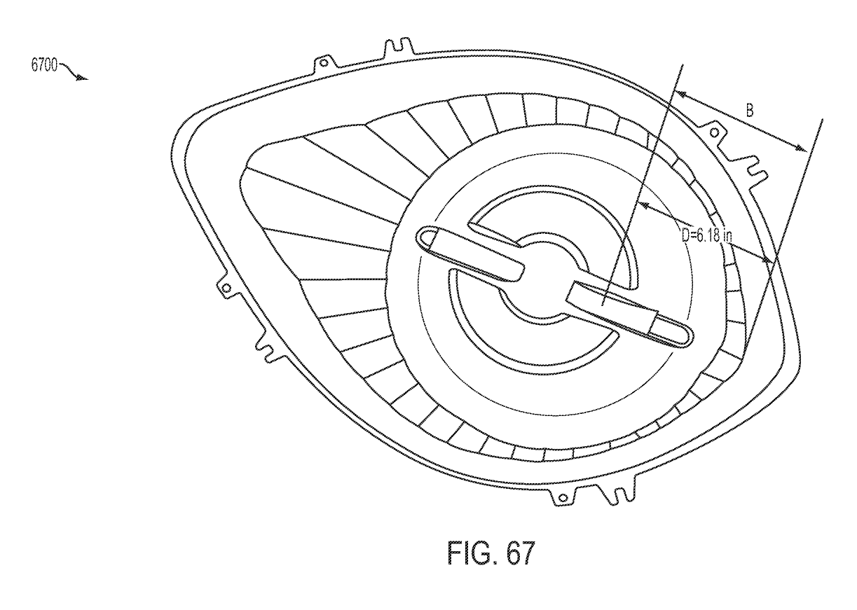

FIG. 67 is a perspective view of a cobra head light fixture reflector 6700 according to an embodiment similar to FIG. 66. As depicted reflector 6700 is configured for a 70 Watt induction-based light source having a circular cross-section tubular arrangement. The distance B between an inner edge of reflector 6700 and the center of the near portion of the tube of induction-based light source is 6.18 inches to achieve a desired illumination distribution. In at least some embodiments, the combination of the reflector 6700 design depicted and a 70 Watt induction-based light source arranged as depicted results in an optimal illumination distribution. In at least some other embodiments, greater or smaller dimensions are used.

In at least some embodiments, expiration of a timer is interchangeable with accumulation to a preset time, i.e., counting up to a preset time versus counting down from the preset time.

Induction lamps as noted, are very efficient at converting energy to light. The additional benefits of embodiments of the lamps, reflectors and refractive elements described in this disclosure make these lamps even more efficient. This allows even lower power consumption for production of the same light output. Moreover, the addition of features allowing the lamp to detect the presence or absence of people and objects allows for the lamp to be extinguished or dimmed when full illumination is not required. This lowers further the average power consumed by the lamp over an extended period, for example, a day or a week.

This lower power consumption enables a number of adaptations to be made to the lighting system that would not otherwise be possible. For example, energy collection devices, such as, but not limited to solar panels and wind turbines may be used to supply all (or in at least some embodiments most) of the power required for the lighting device. In at least some embodiments, this is only possible if the time average power collected by an energy collection device exceeds the time average power consumed by the lighting device. In at least some embodiments, the power collected by solar panels and wind turbines is proportional to the size of the collection device, which is limited to being of similar size or area to the lamp housing.

Energy collection devices, such as, solar panels and wind turbines cannot in general collect power all of the time. Thus, energy storage devices are required to store energy collected, for later use when the lamp is on or active. Energy storage devices may include but are not limited to batteries such as lead acid, NiC, NiMH and lithium ion. The collection devices and batteries generally produce and store power at low voltages, for example, 24V or less. Therefore, operation of the lamp at low voltages becomes useful to avoid unnecessary and wasteful up-conversion of voltages for driving the lamp from a collector or battery.

Furthermore, lamps for public places are typically supplied with high voltage lines, for example 110-240 V because high voltage lines can transmit power over longer distances with lower losses. If the average power consumption of the lamp is significantly reduced, as is the case with the disclosed lamps, efficiently powering the lamp with lower voltages becomes possible because the current losses in the power lines are lower. This allows the lamp controller and electronics to be considerably less expensive because no high to low voltage converters are required, and the housing and electronics no longer need to meet increased safety requirements for the higher voltages.

Thus, combinations of power reduction for the illuminated lamp, reduction in average power consumption of the lamp, lower lamp drive voltages and changes in overall systems configurations produce benefits far over and beyond what might be anticipated by any one adaptation alone.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A light fixture for an induction-based light source, comprising:
a top cover;
a lower cover coupled with the top cover;
a lens coupled with the lower cover;
a reflector positioned behind the lens; and
an induction-based light source positioned between the lens and the reflector,
wherein the reflector is positioned in relation to the induction-based light source.

2. The light fixture as claimed in claim 1, further comprising a controller coupled to the induction-based light source for controlling operation of the induction-based light source.

3. The light fixture as claimed in claim 2, further comprising a sensor coupled with the controller, the sensor being at least one of a motion sensor or an occupancy sensor.

4. The light fixture as claimed in claim 3, the sensor configured to generate a detection signal responsive to detection of a living being in a predetermined area adjacent the light fixture or responsive to detection of motion of the living being in the predetermined area adjacent the light fixture.

5. The light fixture as claimed in claim 2, the controller arranged to cause dimming of the induction-based light source responsive to expiration of a timer.

6. The light fixture as claimed in claim 2, further comprising a power source for converting a mains power supply received into a 24 volt power level; and wherein the induction-based light source is arranged to be driven by the 24 volt power level.

7. The light fixture as claimed in claim 6, wherein the controller is coupled with the power source and arranged to be driven by the 24 volt power level.

8. The light fixture as claimed in claim 6, wherein all electrical components of the light fixture are arranged to be driven by the 24 volt power level.

9. The light fixture as claimed in claim 1, wherein the light fixture is adapted for external installation.

10. The light fixture as claimed in claim 1, wherein the light fixture is at least one of a cobra head light fixture, a shoebox light fixture, a wall pack light fixture, or a walkway light fixture.

11. The light fixture as claimed in claim 1, further comprising:
a casting coupled with the lower cover; and
a support pole coupled with the casting.

12. The light fixture as claimed in claim 1, wherein the lens comprises a refractor optic portion positioned in front of the induction-based light source.

13. The light fixture as claimed in claim 1, wherein the reflector comprises a central hemispherical portion positioned behind the induction-based light source.

14. The light fixture as claimed in claim 6, wherein the reflector comprises a peripheral region having radially extending internal reflection panels.

15. The light fixture as claimed in claim 1, wherein the reflector comprises a peripheral region having radially extending internal reflection panels.

16. The light fixture as claimed in claim 1, wherein the reflector is a radially symmetric, concave and reentrant convex reflector, the concavity of the reflector being positioned around a reentrant convex cone aligned with the center axis of the induction-based light source.

17. The light fixture as claimed in claim 1, wherein the light fixture is configured such that illumination generated by the light source exiting the lamp geometry between 90 degrees and 120 degrees from the light source experiences a single reflection.

18. The light fixture as claimed in claim 1, wherein the lens comprises a single transparent optical unit allowing direct transmission of illumination flux from the light source and direct transmission from inter-reflections from the reflector.

19. The light fixture as claimed in claim 1, further comprising a refractor configured in a radially symmetric geometry molded into a lower encapsulation as an integral element, the refractor is configured such that flux emitted directly downward within 30 degrees to 40 degrees from nadir of the light source is refracted during transmission through the lens geometry.

20. A light fixture for an induction-based light source, comprising:
a housing;
a lens adapted to be coupled with the housing;
a reflector positioned within the housing; and
an induction-based light source positioned between the reflector and the lens, wherein the reflector and light source are positioned in relation to each other to generate a predetermined illumination amount over a predetermined area adjacent the light fixture;
a sensor arranged to generate a detection signal responsive to detection of at least one of a living being within the predetermined area adjacent the light fixture or motion of the living being in the predetermined area adjacent the light fixture; and
a controller coupled with the light source and the sensor, the controller arranged to dim the light source responsive to the detection signal;
wherein each of the controller, the sensor, and the induction-based light source are arranged to be driven by a 24 volt power source.
